(19) United States
(12) Patent Application Publication
(10) Pub. No.: US 2026/0209504 A1
(43) Pub. Date: Jul. 23, 2026

(54) CHIRAL SUPRAMOLECULAR HIGH-ORDER STRUCTURE BASED ON CO-ASSEMBLY OF STAR-SHAPED BLOCK COPOLYMER AND CHIRAL ADDITIVE AND MANUFACTURING METHOD THEREOF

(71) Applicant: EWHA UNIVERSITY-INDUSTRY COLLABORATION FOUNDATION, Seoul (KR)

(72) Inventors: Dong Ha KIM, Seoul (KR); Zhiqun LIN, Seoul (KR); Minju KIM, Bucheon-si (KR)

(21) Appl. No.: 19/530,421

(22) Filed: Feb. 5, 2026

Related U.S. Application Data
(63) Continuation-in-part of application No. PCT/KR2024/006706, filed on May 17, 2024.

(30) Foreign Application Priority Data
Aug. 7, 2023 (KR) 10-2023-0102942

(51) Int. Cl. C08L 53/00; C08J 5/18

(52) U.S. Cl. CPC C08L 53/00; C08J 5/18; C08J 2353/00

(57) ABSTRACT

The present disclosure relates to a chiral supramolecular high-order structure based on a co-assembly and post-treatment of star-like block copolymer (BCP) and a chiral additive, and a method of preparing the same. The chiral supramolecular high-order structure according to the embodiments of the present disclosure is formed through the co-assembly of an achiral star-like block copolymer and a chiral additive. The achiral star-like block copolymer is capable of multiple hydrogen bonding with the chiral additive and may provide a covalently linked unimolecular micelle environment. Accordingly, compared to conventional chiral molecular structures including linear block copolymers, the chiral supramolecular high-order structure of the present disclosure is characterized by a significantly higher yield and a distinct helical handedness transferred from molecular chirality, and exhibits strong supramolecular chirality with an dissymmetry factor of approximately 0.038 which occurs over a wide wavelength range from ultraviolet (UV) to visible light.

### CROSS-REFERENCE TO RELATED APPLICATIONS

This application is a Continuation-in-Part of PCT Application No. PCT/KR2024/006706, filed on May 17, 2024, which claims priority to Korean Patent Application No. 10⁻²⁰²³-010294 filed on Aug. 7, 2023, all of which are hereby incorporated by reference in their entirety.

### TECHNICAL FIELD

The present disclosure relates to a chiral supramolecular high-order structure based on a co-assembly and post-treatment of star-like block copolymer (BCP) and a chiral additive, and a method of preparing the same.

### BACKGROUND

The field of chiral materials has grown significantly, fueled by the inspiration drawn from the abundant chiral architectures found in nature. Among these, chiral supramolecular assemblies have garnered significant attention due to their complexity and diversity in structure and chiroptical activity. These assemblies derive their supramolecular chirality from the asymmetric arrangement of constituent molecules through noncovalent bonds that serve as bridges for the hierarchical transfer of chirality. Supramolecular chirality can arise from chiral components, a mix of chiral and achiral molecules interacting together, or even achiral molecules under chiral environmental influences or conditions. A careful control over multiple parameters can manipulate the production of supramolecular chirality. By meticulously designing the molecular structure of the building blocks, or by controlling dynamic noncovalent interactions, the solvent effect, stoichiometry, temperature, and time, the kinetics and thermodynamics of the chiral supramolecular assembly can be controlled. This has led to the production of a variety of chiral supramolecular structures, such as helical nanotubes, helical microtoroids, and spiral tubes. Interestingly, the chiral supramolecular assembly can also be induced in systems that consist exclusively of achiral molecules. This can be achieved by applying external stimuli, such as asymmetric mechanical forces, circularly polarized light irradiation, or magnetic force. This expansive exploration of chiral supramolecular assembly has provided exciting prospects for the development of advanced materials and functional systems with intriguing properties and applications in diverse scientific fields.

Circularly polarized luminescence (CPL)-active materials have gained increasing interest in the fields of material science and chirality-related applications due to their significant potential in circularly polarized organic light emitting diodes, information encryption, circularly polarized photodetectors, and spintronic devices. Recently, several strategies have been devised for constructing CPL-active materials, including the chemical linkage of chiral molecules to luminescent chromophores, introduction of circularly polarized liquid crystalline filter, and transfer of circularly polarized fluorescence energy from a chiral fluorescent polymer to an achiral fluorophore, among others. Notably, the chiral arrangement of achiral fluorescent dye molecules via chiral supramolecular assembly has been extensively studied. In this approach, chiral information is transferred to achiral dye molecules, which participate in co-assembly through noncovalent interactions. This approach offers advantages such as low manufacturing costs, high stability, and good processability. Moreover, it enables the generation of full-color CPL emission, which is crucial for display technology, and enhances luminescence efficiency by preventing aggregation-induced fluorescence quenching. Despite these advancements, the luminescence dissymmetry factor (glum) values of prepared CPL-active materials typically range between 103 and 10⁻², falling short of our expectations and failing to meet the requirements for practical applications. Therefore, there remains a pressing need for a robust and versatile approach to construct solid CPL materials that possess stable handedness, high luminescence quantum yield (QY), and a significantly high dissymmetry factor.

Star-like polymers represent a relatively simple yet intriguing 3D deviation from linear polymers, with their linear arms extending from a central branching core via covalent bonding. In comparison to linear block copolymers (BCPs), unimolecular star-like BCPs exhibit enhanced stability and resilience against external stimuli, including pH, heat, solvent, or salt concentration. To date, the exploration of chiral supramolecular assembly has been limited to chiral star-like polymers with a lower grafting density (i.e., those having three arms).

Until now, research on chiral supramolecular assemblies has primarily centered on achiral linear BCPs complexed with chiral additives. Yet, this approach, reliant on linear BCPs, has unveiled certain limitations. Specifically, these include a low production yield of helical structures and weak generation of supramolecular chirality in the UV region. Such outcomes are largely attributed to the dynamic and unpredictable assembly process of linear BCPs, which is sensitive to environmental changes.

### PRIOR ART DOCUMENT

### Patent Literature

Korean Laid-open Patent Publication No. 10⁻²⁰²²-0007002
Korean Laid-open Patent Publication No. 10⁻²⁰²³-0064850
Korean Laid-open Patent Publication No. 10⁻²⁰²²-0072504
Korean Registered Patent Publication No. 10⁻²⁵¹⁷⁴²⁸

### Non-Patent Literature

D. A. Siriwardane, O. Kulikov, J. F. Reuther, B. M. Novak, “Rigid, Helical Arm Stars through Living Nickel Polymerization of Carbodiimides”, Macromolecules 2017, 50, 832.

### DISCLOSURE OF THE INVENTION

### Problems to be Solved by the Invention

The present disclosure provides a chiral supramolecular high-order structure based on a co-assembly and post-treatment of star-like block copolymer (BCP) and a chiral additive, and a method of preparing the same.

However, problems to be solved by the present disclosure are not limited to the above-described problems, and although not described herein, other problems to be solved by the present disclosure can be clearly understood by those skilled in the art from the following descriptions.

### Means for Solving the Problems

A first aspect of the present disclosure provides a chiral supramolecular high-order structure, including: an achiral star-like block copolymer including a poly(acrylic acid) as a core block polymer and a shell block polymer; and a chiral additive; wherein the poly(acrylic acid) and the chiral additive have a noncovalent interaction, and wherein a handedness of the chiral supramolecular high-order structure is determined by the chirality of the chiral additive.

A second aspect of the present disclosure provides a circularly polarized luminescence structure, including: the chiral supramolecular high-order structure according to the first aspect; and an achiral fluorophore; wherein a circular polarization direction of the circularly polarized luminescence structure is determined by the handedness of the chiral supramolecular high-order structure.

A third aspect of the present disclosure provides a method of preparing a chiral supramolecular high-order structure, including: preparing a mixed solution including an achiral star-like block copolymer including a poly(acrylic acid) as a core block and a shell block, a chiral additive, and a solvent; stirring the mixed solution; and applying the stirred mixed solution and performing thermal annealing; wherein the poly(acrylic acid) and the chiral additive have a noncovalent interaction, and wherein a handedness of the chiral supramolecular high-order structure is determined by the chirality of the chiral additive.

### Effects of the Invention

The chiral supramolecular high-order structure according to the embodiments of the present disclosure is formed through the co-assembly of an achiral star-like block copolymer and a chiral additive. The achiral star-like block copolymer is capable of multiple hydrogen bonding with the chiral additive and may provide a covalently linked unimolecular micelle environment. Accordingly, compared to conventional chiral molecular structures including linear block copolymers, the chiral supramolecular high-order structure of the present disclosure is characterized by a significantly higher yield and a distinct helical handedness transferred from molecular chirality, and exhibits strong supramolecular chirality with an dissymmetry factor of approximately 0.038 which occurs over a wide wavelength range from ultraviolet (UV) to visible light.

The method of preparing the chiral supramolecular high-order structure according to embodiments of the present disclosure establishes a hierarchical supramolecular chiral structural evolution mechanism by controlling the thermodynamics and kinetics of the co-assembly that forms the chiral supramolecular high-order structure, through the adjustment of thermal annealing time.

The circularly polarized luminescence (CPL) structure according to embodiments of the present disclosure is formed by integrating an achiral fluorophore into a chiral supramolecular high-order structure, and exhibits improved luminescence efficiency with a luminescence dissymmetry factor of up to 0.11.

### BRIEF DESCRIPTION OF THE DRAWINGS

FIG. 1 is a schematic diagram of a step-by-step process for preparing CPL-active hybrid films through co-assembly of achiral star-like PAA-b-PS, R/S-MA, and achiral fluorescent dye molecules according to an embodiment of the present disclosure.

FIGS. 2A to 2C are atomic force microscope (AFM) height images comparing (FIG. 2A) pure star-like PAA-b-PS film with star-like PAA-b-PS films incorporating (FIG. 2B) R-MA and (FIG. 2C)S-MA molecules according to an embodiment of the present disclosure.

FIGS. 3A to 3C show distribution of hydrodynamic radius observed in (FIG. 3A) pure star-like PAA-b-PS, (FIG. 3B) star-like PAA-b-PS incorporating R-MA, and (FIG. 3C) star-like PAA-b-PS incorporating S-MA according to an embodiment of the present disclosure.

FIG. 4 shows FTIR spectra of star-like PAA-b-PS, MA, and star-like PAA-b-PS incorporating MA molecules according to an embodiment of the present disclosure.

FIG. 5 shows hydrogen-bonded conformation between the PAA and S-MA and its hydrogen bonding energy calculated by density functional theory (DFT) according to an embodiment of the present disclosure.

FIGS. 6A(i) to 6B(ii) show SEM images of chiral supramolecular fiber-like structures constructed through the co-assembly of achiral star-like PAA-b-PS with (FIGS. 6A(i) and 6A(ii)) R-MA and (FIGS. 6B(i) and 6B(ii))S-MA according to an embodiment of the present disclosure.

FIGS. 7A(i) to 7B(iii) show gradually magnified SEM images of (FIGS. 7A(i) to 7A(iii)) right-handed fiber-like structures resulting from the co-assembly of achiral star-like PAA-b-PS with R-MA and (FIGS. 7B(i) to 7B(iii)) left-handed fiber-like structures arising from the co-assembly of achiral star-like PAA-b-PS with S-MA according to an embodiment of the present disclosure.

FIGS. 8A to 8C show AFM images with gradually increased magnification of right-handed fiber-like structures obtained from the co-assembly of achiral star-like PAA-b-PS with R-MA, showing nanoscale belt-like structures composed of densely packed dot-like aggregates according to an embodiment of the present disclosure.

FIGS. 9A and 9B show CD and corresponding absorption spectra of (FIG. 9A) R/S-MA in deionized water and (FIG. 9B) chiral supramolecular fiber-like structures constructed through the co-assembly of achiral star-like PAA-b-PS with R/S-MA according to an embodiment of the present disclosure.

FIG. 10 shows spectra of g-factor values for chiral supramolecular structures formed via the co-assembly of achiral star-like PAA-b-PS with R/S-MA, with a molar ratio of AA repeating unit to MA of 1:2 according to an embodiment of the present disclosure.

FIGS. 11A to 11C show DMT modulus images of chiral supramolecular fiber-like structures constructed through the co-assembly of achiral star-like PAA-b-PS with (FIG. 11A) R-MA and (FIG. 11B) S-MA and (FIG. 11C) pure star-like PAA-b-PS film according to an embodiment of the present disclosure. FIGS. 11D to 11F show force-distance curves of chiral supramolecular fiber-like structures constructed through the co-assembly of achiral star-like PAA-b-PS with (FIG. 11D) R-MA and (FIG. 11E) S-MA and (FIG. 11F) pure star-like PAA-b-PS film according to an embodiment of the present disclosure.

FIG. 12 shows annealing time-dependent CD spectra of the composite including star-like PAA-b-PS and S-MA at 60° C. according to an embodiment of the present disclosure.

FIGS. 13A to 13C (ii) show (FIG. 13A) low-resolution SEM (LR-SEM), (FIG. 13B) high-resolution SEM (HR-SEM), and (FIG. 13C (i) and FIG. 13C (ii)) AFM images of the composite film including star-like PAA-b-PS and S-MA after 1 hour of thermal annealing at 60° C. according to an embodiment of the present disclosure.

FIGS. 14A to 14C (ii) show (FIG. 14A) LR-SEM, (FIG. 14B) HR-SEM, and (FIG. 14C (i) and FIG. 14C (ii)) AFM images of the composite film including star-like PAA-b-PS and S-MA after 2 hours of thermal annealing at 60° C. according to an embodiment of the present disclosure.

FIGS. 15A to 15C (ii) show (FIG. 15A) LR-SEM, (FIG. 15B) HR-SEM, and (FIG. 15C (i) and FIG. 15C (ii)) AFM images of the composite film including star-like PAA-b-PS and S-MA after 3 hours of thermal annealing at 60° C. according to an embodiment of the present disclosure.

FIGS. 16A to 16C (ii) show (FIG. 16A) LR-SEM, (FIG. 16B) HR-SEM, and (FIG. 16C (i) and FIG. 16C (ii)) AFM images of the composite film including star-like PAA-b-PS and S-MA after 4 hours of thermal annealing at 60° C. according to an embodiment of the present disclosure.

FIGS. 17A to 17C (ii) show (FIG. 17A) LR-SEM, (FIG. 17B) HR-SEM, and (FIG. 17C (i) and FIG. 17C (ii)) AFM images of the composite film including star-like PAA-b-PS and S-MA after 8 hours of thermal annealing at 60° C. according to an embodiment of the present disclosure.

FIGS. 18A to 18C (ii) show (FIG. 18A) LR-SEM, (FIG. 18B) HR-SEM, and (FIG. 18C (i) and FIG. 18C (ii)) AFM images of the composite film including star-like PAA-b-PS and S-MA after 12 hours of thermal annealing at 60° C. according to an embodiment of the present disclosure.

FIGS. 19A to 19C (ii) show (FIG. 19A) LR-SEM, (FIG. 19B) HR-SEM, and (FIG. 19C (i) and FIG. 19C (ii)) AFM images of the composite film including star-like PAA-b-PS and S-MA after 24 hours of thermal annealing at 60° C. according to an embodiment of the present disclosure.

FIG. 20 shows plausible mechanism of hierarchical chiral supramolecular assembly via co-assembly induced by gradual solvent evaporation and prolonged thermal annealing according to an embodiment of the present disclosure.

FIGS. 21A to 21F show SEM images and g-factor spectra of chiral supramolecular structures constructed via co-assembly of (FIG. 21A, FIG. 21D) star-like PAA homopolymer and R-MA, (FIG. 21B, FIG. 21E) star-like PAA-b-PS (with M_{n, PAA}=100 kg mol⁻¹ and M_{n, PS}=250 kg mol⁻¹) and R-MA, and (FIG. 21C, FIG. 21F) star-like PAA-b-PS (with M_{n, PAA}=100 kg mol⁻¹ and M_{n, PS}=320 kg mol⁻¹) and R-MA according to an embodiment of the present disclosure.

FIG. 22 shows g-factor spectra of chiral supramolecular structures formed via co-assembly of star-like PAA-b-PS (with M_{n, PAA}=100 kg mol⁻¹ and M_{n, PS}=190 kg mol⁻¹) and R-MA at concentrations of 1 mg mL⁻¹, 2.5 mg mL⁻¹, and 5 mg mL⁻¹ according to an embodiment of the present disclosure.

FIGS. 23A to 23C show SEM images of chiral supramolecular structures formed through the co-assembly of star-like PAA-b-PS (with M_{n, PAA}=100 kg mol⁻¹ and M_{n, PS}=190 kg mol⁻¹) and R-MA at different concentrations: (FIG. 23A) 1 mg mL⁻¹, (FIG. 23B) 2.5 mg mL⁻¹, and (FIG. 23C) 5 mg mL 1 according to an embodiment of the present disclosure.

FIGS. 24A to 24C show FTIR spectra of PAA-b-PS/MA, achiral dye molecules, and achiral dye molecules containing PAA-b-PS/MA, wherein (FIG. 24A) PCA, (FIG. 24B) OG, and (FIG. 24C) RhB are used as achiral dye molecules, respectively, according to an embodiment of the present disclosure.

FIGS. 25A to 25C show CD and corresponding absorption spectra of chiral supramolecular hybrid films incorporating (FIG. 25A) PCA, (FIG. 25B) OG, and (FIG. 25C) RhB molecules according to an embodiment of the present disclosure.

FIGS. 26A to 26C show g-factor spectra of chiral supramolecular hybrid films incorporating (FIG. 26A) PCA, (FIG. 26B) OG, and (FIG. 26C) RhB molecules according to an embodiment of the present disclosure.

FIGS. 27A to 27F show CPL spectra and glum spectra of chiral supramolecular hybrid films incorporating (FIG. 27A, FIG. 27D) PCA excited at 350 nm, (FIG. 27B, FIG. 27E) OG excited at 488 nm, and (FIG. 27C, FIG. 27F) RhB molecules excited at 350 nm (Inset images show photographs of the CPL-active hybrid films under 365 nm light irradiation) according to an embodiment of the present disclosure.

FIGS. 28A(i) to 28B(ii) show SEM images of CPL-active supramolecular hybrid film including (FIG. 28A(i) and FIG. 28A(ii)) PAA-b-PS/R-MA and PCA molecules and (FIG. 28B(i) and FIG. 28B(ii)) PAA-b-PS/S-MA and PCA molecules according to an embodiment of the present disclosure.

FIGS. 29A(i) to 29B(ii) show SEM images of CPL-active supramolecular hybrid film including (FIG. 29A(i) and FIG. 29A(ii)) PAA-b-PS/R-MA and OG molecules and (FIG. 29B(i) and FIG. 29B(ii)) PAA-b-PS/S-MA and OG molecules according to an embodiment of the present disclosure.

FIGS. 30A(i) to 30B(ii) show SEM images of CPL-active supramolecular hybrid film including (FIG. 30A(i) and FIG. 30A(ii)) PAA-b-PS/R-MA and RhB molecules and (FIG. 30B(i) and FIG. 30B(ii)) PAA-b-PS/S-MA and RhB molecules according to an embodiment of the present disclosure.

FIGS. 31A and 31B show (FIG. 31A) CPL spectra and (FIG. 31B) glum spectra of chiral supramolecular hybrid films incorporating CsPbBr₃ nanocrystals according to an embodiment of the present disclosure.

FIGS. 32A to 32F show (FIG. 32A, FIG. 32B, FIG. 32C) CPL spectra and corresponding DC spectra, and (FIG. 32D, FIG. 32E, FIG. 32F) glum spectra of chiral supramolecular hybrid films incorporating TPE, HPS, and Py as hydrophobic organic dyes according to an embodiment of the present disclosure.

### BEST MODE FOR CARRYING OUT THE INVENTION

Hereinafter, embodiments and examples of the present disclosure will be described in detail with reference to the accompanying drawings so that the present disclosure may be readily implemented by those skilled in the art. However, it is to be noted that the present disclosure is not limited to the embodiments and examples but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element.

Through the whole document, the term “on” that is used to designate a position of one element with respect to another element includes both a case that the one element is adjacent to the other element and a case that any other element exists between these two elements.

Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise.

Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

Through the whole document, the term “step of” does not mean “step for”.

Through the whole document, the term “combination(s) of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole document, a phrase in the form “A and/or B” means “A or B, or A and B”.

Through the whole document, the term “alkyl” or “alkyl group” may individually include linear or branched alkyl groups having 1 to 12 carbon atoms, 1 to 10 carbon atoms, 1 to 8 carbon atoms, or 1 to 5 carbon atoms, and all the possible isomers thereof. For example, the alkyl or alkyl group may individually include methyl group (Me), ethyl group (Et), n-propyl group (ⁿPr), iso-propyl group (ⁱPr), n-butyl group (ⁿBu), iso-butyl group (ⁱBu), tert-butyl group (^{t}Bu), sec-butyl group (^{s}Bu), n-pentyl group (ⁿPe), iso-pentyl group (ⁱPe), sec-pentyl group (^{s}Pe), tert-pentyl group (^{t}Pe), n-hexyl group, iso-hexyl group, heptyl group, 4,4-dimethyl pentyl group, octyl group, 2,2,4-trimethyl pentyl group, nonyl group, decyl group, undecyl group, dodecyl group, and isomers thereof, but may not be limited thereto.

In the following description, exemplary embodiments of the present disclosure will be described in detail, but the present disclosure may not be limited thereto.

A first aspect of the present disclosure provides a chiral supramolecular high-order structure, including: an achiral star-like block copolymer including a poly(acrylic acid) as a core block polymer and a shell block polymer; and a chiral additive; wherein the poly(acrylic acid) and the chiral additive have a noncovalent interaction, and wherein a handedness of the chiral supramolecular high-order structure is determined by the chirality of the chiral additive.

In an embodiment of the present disclosure, the poly(acrylic acid), which is the core block polymer, and the chiral additive may have a noncovalent interaction through hydrogen bonding.

In an embodiment of the present disclosure, the poly(acrylic acid) and the chiral additive interact non-covalently, whereby the chirality of the chiral additive may be transferred to the core block polymer.

In an embodiment of the present disclosure, the preferred handedness of the chiral supramolecular high-order structure is determined by the chirality of the chiral additive. For example, when the chiral additive is mandelic acid (MA), the chiral supramolecular high-order structure loaded with S-MA may produce a left-handed fiber-like structure, and the chiral supramolecular high-order structure loaded with R-MA may produce a right-handed fiber-like structure.

In an embodiment of the present disclosure, the shell block polymer may be a hydrophobic polymer.

In an embodiment of the present disclosure, the hydrophobic polymer may include at least one selected from the group consisting of polystyrene, polyethylene, polypropylene, polybutadiene, polyaniline, polythiophene, poly(phenylene vinylene), and derivatives thereof, but may not be limited thereto.

In an embodiment of the present disclosure, the polythiophene may be a polyalkyl thiophene including poly(3-ethylthiophene), poly(3-butylthiophene), poly(3-pentylthiophene), or poly(3-hexylthiophene), but may not be limited thereto.

In an embodiment of the present disclosure, the chiral additive may include a chiral carbon having molecular chirality; and a carboxylic acid group and/or a hydroxyl group as a functional group capable of multiple hydrogen bonding with an acrylic acid (AA) repeating unit of the poly(acrylic acid), but may not be limited thereto.

In an embodiment of the present disclosure, the chiral additive may include at least one selected from the group consisting of mandelic acid, tartaric acid, aspartic acid, tyrosine, ibuprofen, and hydroxymandelic acid, but may not be limited thereto.

In an embodiment of the present disclosure, the achiral star-like block copolymer may have a star-like structure including a plurality of arms extending from the core block polymer. The achiral star-like block copolymer may have a star-like structure including 21 arms extending from the core block polymer.

In an embodiment of the present disclosure, the achiral star-like block copolymer may include a plurality of arms extending from the core block polymer, and the achiral star-like block copolymer may be formed by the shell block polymer being bonded to each of the plurality of arms.

In an embodiment of the present disclosure, the achiral star-like block copolymer may be an amphiphilic polymer including a hydrophilic core block polymer and a hydrophobic shell block polymer. In an embodiment of the present disclosure, the core block polymer is a hydrophilic polymer and the shell block polymer is a hydrophobic polymer, wherein phase separation may occur due to chemical incompatibility between the core block polymer and the shell block polymer during the formation of the chiral supramolecular high-order structure through co-assembly.

In an embodiment of the present disclosure, the achiral star-like block copolymer is capable of multiple hydrogen bonding with the chiral additive and may provide a unimolecular micelle environment linked by covalent bonds. Accordingly, compared to conventional chiral molecular structures including linear block copolymers, the chiral supramolecular high-order structure of the present disclosure is characterized by a significantly higher yield and a distinct helical handedness transferred from molecular chirality, and exhibits strong supramolecular chirality with an dissymmetry factor of approximately 0.038 which occurs over a wide wavelength range from ultraviolet (UV) to visible light.

In an embodiment of the present disclosure, a volume ratio of the core block polymer to the shell block polymer may be about 1:1 to about 1:4, but may not be limited thereto. In an embodiment of the present disclosure, the volume ratio of the core block polymer to the shell block polymer may be about 1:1 to about 1:4, about 1:1 to about 1:3, or about 1:1 to about 1:2, but may not be limited thereto.

In an embodiment of the present disclosure, the chiral supramolecular high-order structure may form a belt-like structure.

In an embodiment of the present disclosure, the chiral supramolecular high-order structure may form a helical fiber-like structure.

In an embodiment of the present disclosure, the chiral supramolecular high-order structure may be formed through a series of co-assembly processes of the achiral star-like block copolymer and the chiral additive, including: transferring the chirality of the chiral additive to the core block polymer to form a chiral star-like block copolymer; aggregating the chiral star-like block copolymer to form aggregates; packing the aggregates to form a belt-like structure; and packing the belt-like structure to form a helical fiber-like structure.

In an embodiment of the present disclosure, the belt-like structure may be nanosized, ranging from about 50 nm to about 500 nm. In an embodiment of the present disclosure, the fiber-like structure may be microsized, ranging from about 1 μm to about 100 μm.

In an embodiment of the present disclosure, a dissymmetry factor (g-factor) of the chiral supramolecular high-order structure may be about 0.03 or more, or about 0.03 to about 0.038. In an embodiment of the present disclosure, the dissymmetry factor of the chiral supramolecular high-order structure may be greater than those observed in chiral supramolecular structures constructed via co-assembly of achiral linear block copolymer and a chiral additive, as well as self-assembly of a chiral block copolymer.

In an embodiment of the present disclosure, the chiral supramolecular high-order structure is formed into the helical fiber-like structure, thereby improving mechanical properties such as elastic modulus or hardness (H) when formed into a thin film.

In an embodiment of the present disclosure, an elastic modulus value of the chiral supramolecular high-order structure may be about 0.1 GPa or more, or about 0.1 GPa to about 0.106 GPa.

A second aspect of the present disclosure provides a circularly polarized luminescence structure, including: the chiral supramolecular high-order structure according to the first aspect; and an achiral fluorophore; wherein a circular polarization direction of the circularly polarized luminescence structure is determined by the handedness of the chiral supramolecular high-order structure.

Detailed descriptions of parts of the second aspect, which overlap with those of the first aspect, are omitted hereinafter, but the descriptions of the first aspect of the present disclosure may be identically applied to the second aspect of the present disclosure, even though they are omitted hereinafter.

In an embodiment of the present disclosure, the achiral fluorophore may be a dye compound including at least one selected from the group consisting of 1-pyrenecarboxylic acid, Oregon Green 488, rhodamine, anthracene-9-carboxylic acid, terephthalic acid, naphthalene dicarboxylic acid, coumarin, coumarin-6-carboxylic acid, 7-hydroxy-4-methylcoumarin-3-carboxylic acid, naphthalene-1,8-dicarboxylic acid, tetraphenylethylene, hexaphenylsilole, pyrene, perylene, anthracene, and Nile red; a semiconductor compound including at least one selected from CdS, CdSe, and PbS; a perovskite nanocrystal compound including at least one selected from CsPbX₃ (cesium lead halide) and MAPbX₃ (methylammonium lead halide); or an upconversion nanoparticle including at least one selected from NaYF₄:Yb, Er (ytterbium and erbium doped NaYF₄) and NaYF₄:Yb, Tm (ytterbium and thulium doped NaYF₄).

In an embodiment of the present disclosure, the CsPbX₃ may be, as non-limiting examples, CsPbF₃, CsPbCl₃, CsPbBr₃, CsPbl₃, CsPbBr₂I, or CsPbBrI₂. In an embodiment of the present disclosure, the MAPbX₃ may be, as non-limiting examples, MAPbF₃, MAPbCl₃, MAPbBr₃, MAPbI₃, MAPbBr₂I, or MAPbBrI₂.

In an embodiment of the present disclosure, the dye compound may include a carboxylic acid group as a functional group. In an embodiment of the present disclosure, by including the carboxylic acid group as a functional group, the dye compound may form hydrogen bonds with the acrylic acid repetitive units of the chiral supramolecular high-order structure and the chiral additive.

In an embodiment of the present disclosure, the semiconductor compound, the perovskite nanocrystal compound, and the upconversion nanoparticle may be contained by being grown within the polyacrylic acid, which is the core block polymer.

In an embodiment of the present disclosure, a luminescence dissymmetry factor (glum) of the circularly polarized luminescence structure may be about 0.03 or more, or about 0.03 to about 0.11.

In an embodiment of the present disclosure, the circularly polarized luminescence structure may exhibit a higher photoluminescence quantum yield (PLQY) compared to a film including purely achiral fluorophore.

A third aspect of the present disclosure provides a method of preparing a chiral supramolecular high-order structure, including: preparing a mixed solution including an achiral star-like block copolymer including a poly(acrylic acid) as a core block and a shell block, a chiral additive, and a solvent; stirring the mixed solution; and applying the stirred mixed solution and performing thermal annealing; wherein the poly(acrylic acid) and the chiral additive have a noncovalent interaction, and wherein a handedness of the chiral supramolecular high-order structure is determined by the chirality of the chiral additive.

Detailed descriptions of parts of the third aspect, which overlap with those of the first aspect and the second aspect, are omitted hereinafter, but the descriptions of the first aspect and the second aspect of the present disclosure may be identically applied to the third aspect of the present disclosure, even though they are omitted hereinafter.

In an embodiment of the present disclosure, by stirring the mixed solution, non-covalent interaction (hydrogen bonding) is formed between the acrylic acid repeating units of the polyacrylic acid and the chiral additive, thereby forming a complex (chiral star-like block copolymer) including the achiral star-like block copolymer and the chiral additive.

In an embodiment of the present disclosure, the stirring may be performed for about 1 day or more, about 2 days or more, or about 1 day to about 10 days, but may not be limited thereto.

In an embodiment of the present disclosure, the solvent may include at least one selected from the group consisting of dimethylformamide, toluene, tetrahydrofuran, ethyl acetate, 1,4-dioxane, dimethyl sulfoxide, acetonitrile, acetone, ethanol, and methanol, but may not be limited thereto. In an embodiment of the present disclosure, the solvent may exhibit excellent solubility for both the achiral star-like block copolymer and the chiral additive, thereby facilitating the formation of non-covalent interaction (hydrogen bonding) between the acrylic acid repeating units of the polyacrylic acid and the chiral additive.

In an embodiment of the present disclosure, during the thermal annealing process, the chiral additive that has not formed hydrogen bonds with the acrylic acid repeating units may be thermally decomposed. Therefore, to ensure that all acrylic acid repeating units form hydrogen bonds (non-covalent interaction) with the chiral additive—thereby enabling efficient chirality transfer—the mixed solution may include an excess of the chiral additive relative to the number of acrylic acid repeating units.

In an embodiment of the present disclosure, a molar ratio of an acrylic acid repeating unit of the poly(acrylic acid) to the chiral additive is about 1:1 to about 1:3, but may not be limited thereto. In an embodiment of the present disclosure, the molar ratio of an acrylic acid repeating unit of the poly(acrylic acid) to the chiral additive is about 1:1 to about 1:3, about 1:1 to about 1:2.5, about 1:1 to about 1:2, about 1:1.5 to about 1:3, about 1:1.5 to about 1:2.5, or about 1:1.5 to about 1:2, but may not be limited thereto.

In an embodiment of the present disclosure, co-assembly of the achiral star-like block copolymer and the chiral additive may be performed through the thermal annealing, thereby forming the chiral supramolecular high-order structure.

In an embodiment of the present disclosure, the formation mechanism of the chiral supramolecular high-order structure according to the lapse of thermal annealing time is described in more detail as follows:

1) Within the mixed solution, a complex (chiral star-like block copolymer) including the achiral star-like block copolymer and the chiral additive is formed as a primary structure. 2) During the initial stage of the thermal annealing, as the solvent begins to evaporate, the concentration of the complex gradually increases, and the complexes aggregate with each other to form irregular dot-like aggregates having diameters in the nanometer range. 3) As the thermal annealing progresses, the dot-like aggregates undergo elongated packing to form a belt-like structure. 4) As the thermal annealing continues further, the belt-like structures undergo helical packing to form a fiber-like structure having a specific handedness.

In an embodiment of the present disclosure, the thermal annealing is performed at a temperature range of about 50° C. to about 70° C., but may not be limited thereto. In an embodiment of the present disclosure, the thermal annealing is performed at a temperature range of about 50° C. to about 70° C., about 50° C. to about 65° C., about 55° C. to about 70° C., or about 55° C. to about 65° C., but may not be limited thereto.

In an embodiment of the present disclosure, the thermal annealing is performed for about 1 hour to about 48 hours, but may not be limited thereto.

In an embodiment of the present disclosure, a volume ratio of the core block polymer to the shell block polymer is about 1:1 to about 1:4, but may not be limited thereto. In an embodiment of the present disclosure, the volume ratio of the core block polymer to the shell block polymer is about 1:1 to about 1:4, about 1:1 to about 1:3, or about 1:1 to about 1:2, but may not be limited thereto.

In an embodiment of the present disclosure, the achiral star-like block copolymer may be an amphiphilic polymer including a hydrophilic core block polymer and a hydrophobic shell block polymer. In an embodiment of the present disclosure, the core block polymer is a hydrophilic polymer and the shell block polymer is a hydrophobic polymer, wherein phase separation may occur due to chemical incompatibility between the core block polymer and the shell block polymer during the formation of the chiral supramolecular high-order structure through co-assembly.

In an embodiment of the present disclosure, when the volume ratio of the core block polymer to the shell block polymer is less than about 1:1, sufficient phase separation between the core block polymer and the shell block polymer may not occur, which can result in the formation of irregular chiral supramolecular high-order structures with a low dissymmetry factor. On the other hand, when the volume ratio is more than about 1:4, the chiral supramolecular high-order structures may fail to reach a thermodynamically stable state even after thermal annealing for an appropriate time, potentially leading to the formation of kinetically trapped structures.

In an embodiment of the present disclosure, a concentration of the mixed solution is more than 1 mg mL⁻¹ and up to about 10 mg mL⁻¹, but may not be limited thereto. In an embodiment of the present disclosure, the concentration of the mixed solution is more than 1 mg mL” 1 and up to about 10 mg mL⁻¹, more than 1 mg mL⁻¹ and up to about 7 mg mL⁻¹, more than 1 mg mL⁻¹ and up to about 5 mg mL⁻¹, more than 1 mg mL 1 and up to about 3 mg mL⁻¹, about 2 mg mL 1 to about 10 mg mL 1, about 2 mg mL⁻¹ to about 7 mg mL⁻¹, about 2 mg mL⁻¹ to about 5 mg mL⁻¹, or about 2 mg mL⁻¹ to about 3 mg mL⁻¹, but may not be limited thereto. In an embodiment of the present disclosure, when the concentration of the mixed solution is 1 mg mL⁻¹ or less, the chiral supramolecular high-order structure fails to exhibit a distinct handedness, resulting in weak chirality. On the other hand, when the concentration of the mixed solution is more than about 10 mg mL⁻¹, it may hinder the evolution of the chiral supramolecular high-order structure.

In an embodiment of the present disclosure, the method of preparing a chiral supramolecular high-order structure further includes, prior to performing the thermal annealing, adding an achiral fluorophore to the stirred mixed solution and stirring it.

In an embodiment of the present disclosure, In an embodiment of the present disclosure, the achiral fluorophore may be a dye compound including at least one selected from 1-pyrenecarboxylic acid, Oregon Green 488, rhodamine, anthracene-9-carboxylic acid, terephthalic acid, naphthalene dicarboxylic acid, coumarin, coumarin-6-carboxylic acid, 7-hydroxy-4-methylcoumarin-3-carboxylic acid, naphthalene-1,8-dicarboxylic acid, tetraphenylethylene, hexaphenylsilole, pyrene, perylene, anthracene, and Nile red; a semiconductor compound including at least one selected from CdS, CdSe, and PbS; a perovskite nanocrystal compound including at least one selected from CsPbX₃ (cesium lead halide) and MAPbX₃ (methylammonium lead halide); or an upconversion nanoparticle including at least one selected from NaYF₄:Yb, Er (ytterbium and erbium doped NaYF₄) and NaYF₄:Yb, Tm (ytterbium and thulium doped NaYF₄).

In an embodiment of the present disclosure, the CsPbX₃ may be, as non-limiting examples, CsPbF₃, CsPbCl₃, CsPbBr₃, CsPbl₃, CsPbBr₂₁, or CsPbBrl₂. In an embodiment of the present disclosure, the MAPbX₃ may be, as non-limiting examples, MAPbF₃, MAPbCl₃, MAPbBr₃, MAPbI₃, MAPbBr₂I, or MAPbBrI₂.

In an embodiment of the present disclosure, the dye compound may include a carboxylic acid group as a functional group. In an embodiment of the present disclosure, by including the carboxylic acid group as a functional group, the dye compound may form hydrogen bonds with the acrylic acid repetitive units of the chiral supramolecular high-order structure and the chiral additive.

In an embodiment of the present disclosure, the semiconductor compound, the perovskite nanocrystal compound, and the upconversion nanoparticle may be contained by being grown within the polyacrylic acid, which is the core block polymer.

In an embodiment of the present disclosure, when the achiral fluorophore is the dye compound, the molar ratio of the acrylic acid repeating units of the poly(acrylic acid) to the dye compound may be about 1:0.05 to about 0.3, about 1:0.05 to about 0.25, about 1:0.1 to about 0.3, or about 1:0.1 to about 0.25, but may not be limited thereto.

In an embodiment of the present disclosure, adding the achiral fluorophore to the stirred mixed solution and stirring it may be performed for about 1 day or more, about 2 days or more, or about 1 day to about 10 days, but may not be limited thereto.

Hereinafter, the present disclosure will be described in more detail with reference to Examples, but the present disclosure may not be limited thereto.

### MODE FOR CARRYING OUT THE INVENTION

### Examples

### 1. Experimental Method

### 1-1. Materials

Toluene (99.5%), dichloromethane (DCM, >99.5%), a-bromoisobutyryl bromide (BiBB, 98%), anisole (99%), 2-butanone (methyl ethyl ketone, MEK, 99.0%), anhydrous dimethylformamide (DMF, >99.8%), anhydrous 1-methyl-2-pyrrolidinone (NMP, 99.5%), N,N,N′, N′,N″-pentamethyldiethylene triamine (PMDETA, 99%), trifluoroacetic acid (TFA, 99.9%), diethyl ether (anhydrous, 99.0%), ethanol (anhydrous, 99.5%), calcium hydride (CaH₂, for synthesis), sodium bicarbonate (NaHCO₃, 99.7%), aluminum oxide powder (activated, neutral, ~325 mesh), tetrahydrofuran (THF, 99.0%), acetone (99.5%), magnesium sulfate (MgSO₄, anhydrous, 99.5%), benzyl alcohol (BA, anhydrous, 99.8%), diphenyl ether (DPE, 99%), deuterated chloroform (CDCl₃, 99.96%), acetic acid (99.7%), and rhodamine B (RhB, ≥95%) were purchased from Sigma-Aldrich and used without further purification. D-(−)-mandelic acid (R-MA, >99.0%) and L-(+)-mandelic acid (S-MA, >99.0%) were acquired from Tokyo Chemical Industry (TCI) and used in their received state without any additional purification processes. 2′,7′-Difluorofluorescein (Oregon Green™ 488, OG) was obtained from Thermo Fisher Scientific and used without further purification. B-cyclodextrin (B-CD, >97.0%, Sigma-Aldrich) was subjected to vacuum drying for 48 hours at 60° C. and then azeotropically distilled in toluene for 2 hours at 120° C. prior to the esterification reaction. Copper (I) bromide (CuBr, 98%, Sigma-Aldrich) was stirred for 2 hours in acetic acid, then filtered, washed with ethanol and diethyl ether, and finally dried under vacuum at room temperature overnight. Styrene (St, 99.9%, Sigma-Aldrich) and tert-butyl acrylate (tBA, 98%, Sigma-Aldrich) were distilled over CaH₂ under reduced pressure prior to use. 1-Pyrenecarboxylic Acid (PCA, >97.0%) purchased from TCI was purified through crystallization using ethanol as a solvent.

### 1-2. Synthesis of Star-Like PAA-b-PS

### 1) Synthesis of Brominated β-CD Initiator (Br-β-CD)

The initial step involved dissolving β-CD (2.5 mmol) in anhydrous NMP (40 mL), and subsequently cooling the solution to 0° C. using an ice bath. Following this, BiBB (105 mmol) was carefully added to the solution over a period of an hour, all the while maintaining vigorous stirring. After the complete addition of BiBB, the mixture was allowed to stir for an additional hour at 0° C. The mixture was then allowed to slowly warm to room temperature, after which stirring was continued for 24 more hours. The resulting crude solution was expanded with DCM, then repeatedly washed with a saturated NaHCO₃ aqueous solution and deionized water. The final product was obtained by evaporating the DCM using a rotary evaporator, followed by drying the residue in a vacuum oven overnight at room temperature.

### 2) Synthesis of Star-Like Poly(Tert-Butyl Acrylate) (PtBA)

The first step involved combining Br-β-CD (macroinitiator), CuBr (catalyst), PMDETA (ligand), tBA (monomer), and MEK (solvent) in an ampoule. The molar ratio for the reaction components, Br-β-CD, CuBr, PMDETA, MEK, and tBA was maintained at 1:1:2:2000:1000. The mixture was then purged with N₂ for 1 hour to eliminate any oxygen present. After this, the ampoule was sealed and immersed in a preheated oil bath set to 60° C. To halt the polymerization at specific durations, the ampoule was taken out of the oil bath, cooled rapidly in an ice bath, and then exposed to air. The resulting crude solution was diluted with acetone and then passed through a neutral alumina column to eliminate the catalyst. This was followed by precipitation in a water/methanol mixture (v:v=1:1). After filtration, the final product was dried in a vacuum oven at room temperature.

### 3) Synthesis of Star-Like Poly(Tert-Butyl Acrylate)-Block-Polystyrene (PtBA-b-PS)

The prepared star-like PtBA polymer, CuBr, PMDETA, styrene, and anisole were combined in an ampoule and purged with nitrogen gas for 1 hour to eliminate any oxygen. The molar ratio for the reaction components, bromine in star-like PtBA, CuBr, PMDETA, anisole, and St was set to be 1:1:2:2000:1000. The ampoule was then sealed and submerged in an oil bath set at 90° C.

The polymerization process was stopped at certain intervals by removing the ampoule from the oil bath, cooling it in an ice bath, and then exposing it to the open air. The resulting crude solution was diluted with THF, passed through a neutral alumina column to extract the catalyst, and then precipitated in a water/methanol mixture (v:v=1:1). After filtration, the final product was dried in a vacuum oven at room temperature.

### 4) Synthesis of Star-Like Poly(Acrylic Acid)-Block-Polystyrene (PAA-b-PS)

The first step involved dissolving the PtBA-b-PS star-like block copolymer in anhydrous DCM. This was followed by the gradual addition of TFA under vigorous stirring at room temperature, triggering hydrolysis. After a period of 24 hours, the DCM was removed using a rotary evaporator. The product, PAA-b-PS, was then purified through a dissolution-precipitation process using DMF and methanol. Finally, the product was dried in a vacuum oven at room temperature.

### 1-3. Preparation of Chiral Fiber-Like Supramolecular Structures

Chiral fiber-like supramolecular structures were obtained through the co-assembly of star-like BCP and R/S-MA. Initially, star-like PAA-b-PS (2.5 mg) and R/S-MA were dissolved in 1 mL of DMF and stirred for a minimum of two days at room temperature to ensure sufficient hydrogen bonding interactions between AA repeating units and R/S-MA. The molar ratio of the AA repeating unit to MA was maintained at 1:2. The mixed solution was purified by passing through a 200 nm PTFE filter and then evenly drop-cast onto a substrate, such as silica, glass, or quartz. Subsequently, the film was annealed at 60° C. for 24 hours, during which the solvent slowly evaporated, and fiber-like structures progressively formed.

### 1-4. Preparation of CPL-Active Hybrid Films

Star-like PAA-b-PS (2.5 mg) and R/S-MA were initially mixed in 1 mL of DMF. This mixture was then stirred at room temperature for at least 48 hours, keeping the molar ratio of the AA repeating unit to MA at 1:2. Subsequently, achiral fluorescent dye molecules were prepared in a small volume of DMF (<100 μL), and then added to the mixed solution of PAA-b-PS and R/S-MA. The molar ratios of the AA repeating unit to 1-Pyrenecarboxylic Acid (PCA, a blue dye), Oregon Green™ 488 (OG, a green dye), and rhodamine B (RhB, a red dye) were kept at 1:0.25, 1:0.1, and 1:0.1, respectively. This mixture was then stirred for 24 hours at a temperature between 5° C. and 10° C. in the dark to avoid light and heat-induced degradation. Following this, the solution was filtered with a 200 nm PTFE syringe filter and drop-casted evenly onto a substrate (such as silica, glass, or quartz). The resulting film was then subjected to annealing at 60° C. overnight, during which the solvent slowly evaporated and chiral supramolecular structures formed.

### 2. Results

### 2-1. Versatile Strategy for Constructing CPL-Active Hybrid Films Using Star-Like BCP-Based Chiral Supramolecular Templates

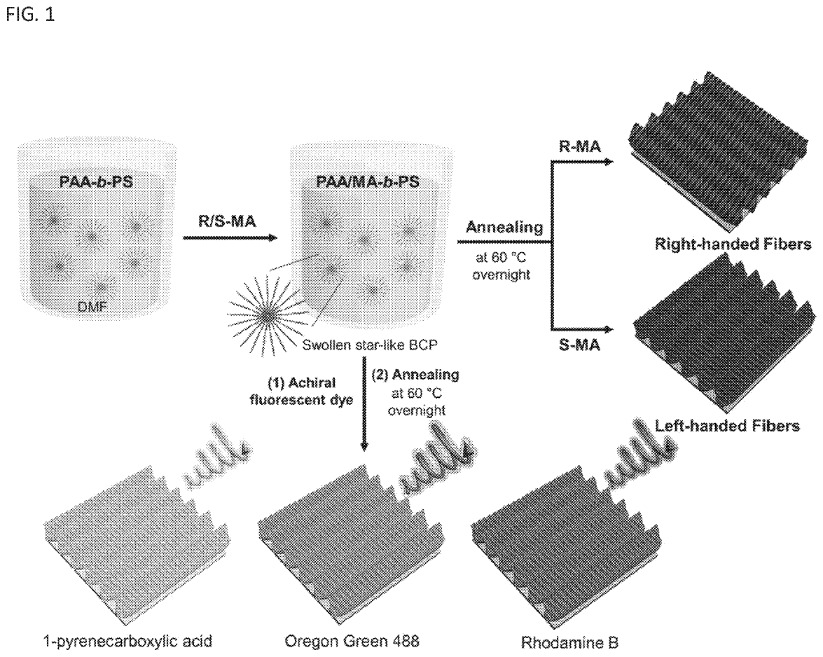

FIG. 1 presents a detailed step-by-step process for the creation of CPL-active hybrid films. This process leverages the technique of chiral supramolecular co-assembly mediated by noncovalent interactions. The first stage in this procedure involves the introduction of chiral additives, R/S-MA, into a star-like PAA-b-PS solution in DMF. This results in the formation of swollen chiral star-like BCPs. It is noted that the interaction between the PAA block and MA is driven by hydrogen bonds, which facilitate an efficient chirality transfer from the MA to the polymer chain. Following this, the resulting mixed solution is uniformly drop-casted onto a substrate. It then undergoes thermal annealing, a process that promotes a high-order helical phase transition within the chiral supramolecular co-assemblies. Given an adequate time for annealing, chiral supramolecular structures with a preferred handedness are formed, where the handedness is determined by the chirality of R/S-MA. In the next step of this process, to exploit chiral co-assembly driven by noncovalent interactions and thermal annealing, diverse achiral fluorescent dye molecules with multiple hydrogen bonding sites are added and then the same procedures are performed. Interestingly, chiral supramolecular structures which incorporate the achiral dye molecules are obtained. These structures emit characteristic CPL emissions, the direction of which is determined by the handedness of supramolecular structures, indicating that the dye molecules have successfully arranged themselves in a chiral manner. This entire process highlights an intriguing and versatile approach to integrating chiral and achiral components in a way that enables the manipulation of CPL emissions.

### 2-2. Incorporation of Chiral Additives into Star-Like BCPs

Hereinafter, the step-by-step process of synthesizing star-like amphiphilic unimolecular poly(acrylic acid)-block-polystyrene (PAA-b-PS) is described in detail. Initially, 21 hydroxyl end groups of β-CD were transformed to bromine groups through esterification, resulting in the formation of 21-Br-β-CD macroinitiator. Proton nuclear magnetic resonance (1H-NMR) was employed to confirm the esterification of 21 hydroxyl groups on β-CD. The conversion efficiency was calculated to be 98%, considering the ratio of the integral area of the residual protons on β-CD to the integral area of the methyl protons. Utilizing the 21-Br-β-CD macroinitiator, a series of ATRP reactions were performed using tBA and St monomers, leading to the formation of well-defined diblock copolymers, poly(tert-butyl acrylate)-block-polystyrene (PtBA-b-PS), with a narrow molecular weight distribution. Finally, the inner hydrophobic PtBA blocks were converted into hydrophilic PAA blocks by extensively hydrolyzing the tert-butyl groups of PtBA. This transformation yielded amphiphilic star-like PAA-b-PS diblock copolymers. To ensure successful hydrolysis, additional confirmation was obtained through Fourier transform infrared spectra (FTIR) measurements. A broad absorbance spanning the range of 2500 cm⁻¹ to 3600 cm⁻¹ appeared after the hydrolysis, indicating the formation of carboxylic acid group. Moreover, there was a noticeable shift in the carbonyl stretching peak from 1727 cm⁻¹ in PtBA-b-PS to 1700 cm⁻¹ in PAA-b-PS. These findings provide further evidence of the hydrolysis process and the successful conversion of the PtBA blocks into PAA blocks.

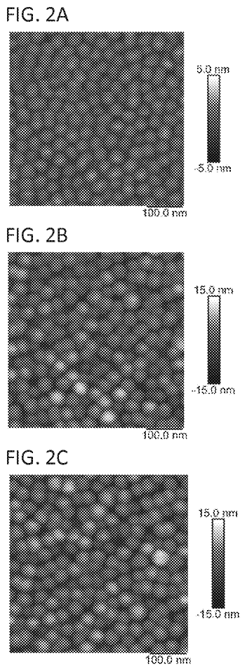

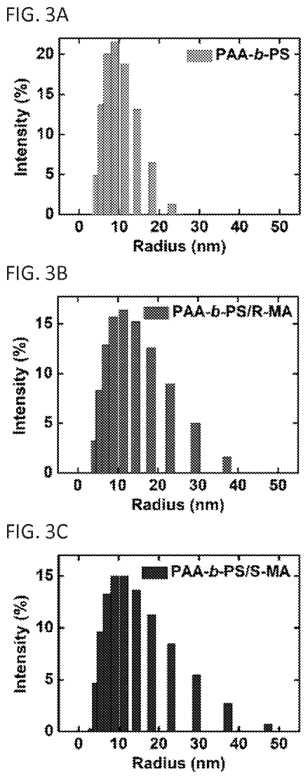

The incorporation of enantiopure MA into star-like PAA-b-PS (with M_{n, PAA}=100 kg mol⁻¹ and M_{n, PS}=190 kg mol⁻¹) was achieved through noncovalent interactions between their multiple functional groups. To facilitate the complexation between the two components, PAA-b-PS and R/S-MA were mixed in DMF which serves as good solvent for both the polymer blocks and R/S-MA. The molar ratio of AA repeating unit to R/S-MA was set at 1:2. The resulting mixtures were then compared to pure star-like PAA-b-PS using atomic force microscopy (AFM) to analyze their sizes and morphologies (FIGS. 2A to 2C). Spherical unimolecular micelles were clearly observed regardless of whether a complex of PAA-b-PS and R/S-MA was formed. However, it is worth noting that the average diameter of the star-like micelles increased from 30.5 nm to 37 nm after the incorporation of enantiopure MA. This size expansion was further confirmed through dynamic light scattering (DLS) measurements, which indicated an increase in hydrodynamic diameters from 19.7 nm to 26.9 nm for R-MA and 27.3 nm for S-MA (FIGS. 3A to 3C). It is important to consider that the collapsed state and stretched state of the samples used for AFM and DLS measurements, respectively, may result in different obtained sizes, as each technique captures the structures in different states.

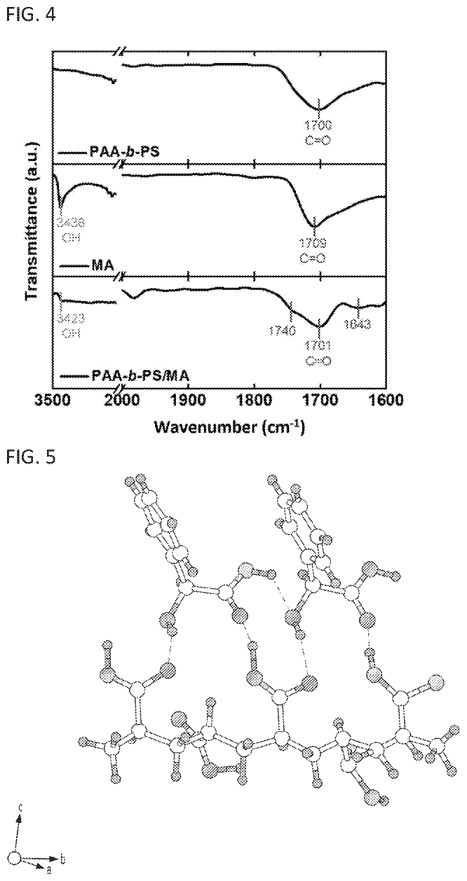

The noncovalent interaction between star-like PAA-b-PS and enantiopure MA was thoroughly examined using FTIR and density functional theory (DFT) calculation. In the FTIR spectra (FIG. 4), the stretching vibration bands of the carbonyl group in both the PAA block of the star-like BCP and MA were observed at 1700 cm⁻¹ and 1709 cm⁻¹, respectively. Notably, upon complexation, these bands split into multiple bands within a broadened range of 1640 cm⁻¹ to 1740 cm⁻¹, indicating the presence of more intricate interactions. Furthermore, an intriguing shift was observed for the methylenic O—H stretching mode of MA, moving from 3438 cm⁻¹ to 3423 cm⁻¹. This shift can be attributed to the formation of hydrogen bonding interactions between MA and the PAA block of the star-like BCP. Further insights from computational studies using DFT showed that one MA molecule can favorably form two intermolecular hydrogen bonds, denoted as a [O—H . . . . O] linkage, with the AA repeating units (FIG. 5). This interaction exhibited a negative hydrogen bonding energy, indicating that the formation of these bonds is energetically preferred. This result provides compelling evidence of the presence of strong hydrogen bonding interactions between the MA and the PAA block. The significance of these noncovalent interactions is underlined by the fact that they act as a major driving force for the transfer of chirality from the chiral additive to the originally achiral star-like BCPs. The findings from DFT, showing strong hydrogen bonding, support this mechanism, providing a plausible explanation for the efficient transfer of chirality from MA to the PAA chain.

### 2-3. Formation of Chiral Supramolecular Structures Via Co-Assembly

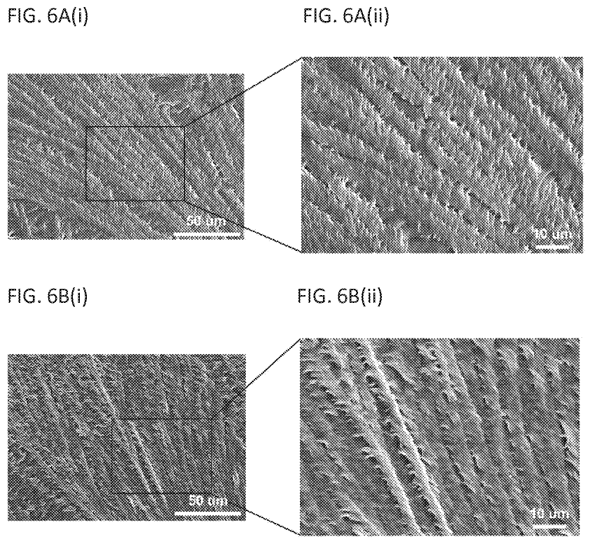

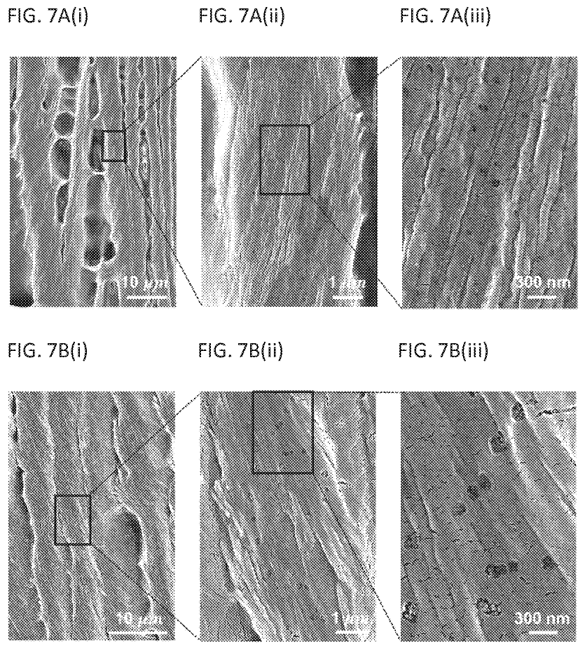

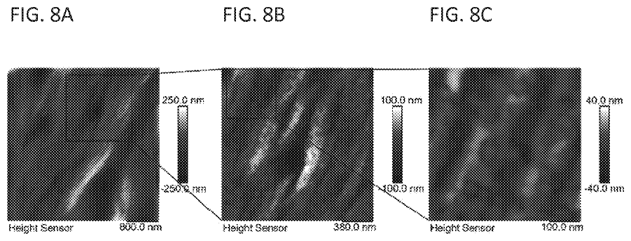

Chiral supramolecular structures with a specific handedness were successfully synthesized through drop-casting their DMF solutions, followed by a thermal annealing-driven co-assembly process at 60° C. Prolonged annealing times facilitated the transfer of chirality from chiral additives to the hierarchical co-assembly, resulting in the formation of macroscopic helical fiber-like structures. Scanning electron microscope (SEM) images (FIGS. 6A(i), 6A(ii), 6B(i) and 6B(ii)) clearly depict the handedness of the obtained fiber-like structures, which is determined by the molecular chirality of the chiral additive MA. Specifically, R-MA loaded star-like BCP films yielded right-handed fiber-like structures, while S-MA loaded star-like BCP films gave rise to left-handed fiber-like structures. These structures exhibited an average width of 3.5 μm. Importantly, these chiral structures contrast with the self-assembled structures observed in pure star-like BCP films subjected to the same thermal annealing conditions. In the absence of chiral additives, SEM and AFM images revealed mixed morphologies consisting of lamellae and spheres. Upon closer examination using SEM at high magnification (FIGS. 7A(i), 7A(ii), 7A(iii), 7B(i), 7B(ii) and 7B(iii)), it is evident that the microscale fiber-like structures are composed of nanoscale belt-like structures. Further analysis using atomic force microscopy (AFM) revealed that these nanoscale belt-like structures consist of densely packed dot-like structures (FIGS. 8A to 8C).

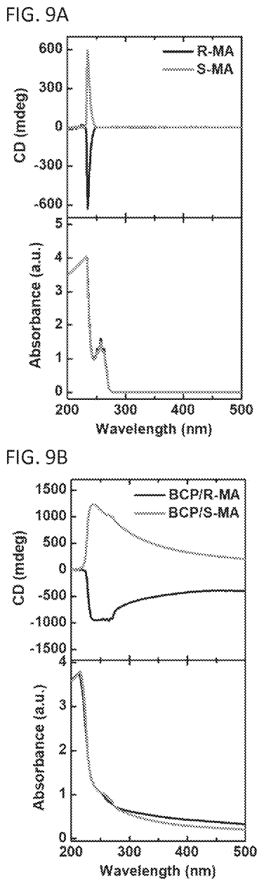

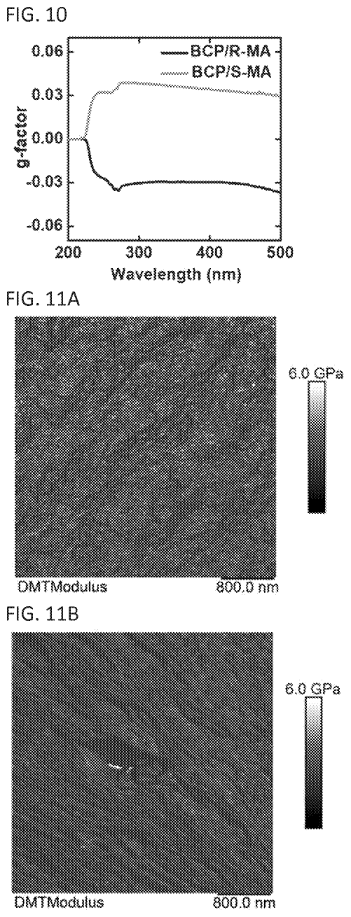

Remarkably, the chiral supramolecular fiber-like structures exhibited strong supramolecular chirality that differed significantly from the molecular chirality of R/S-MA. The CD spectra of pure R/S-MA dissolved in deionized water displayed intense peaks corresponding to the n-π* transition of the carboxylic acid group (FIG. 9A), indicating molecular-level chiroptical activity attributed to the chiral center of MA. However, upon hybridization of R/S-MA with achiral star-like BCPs, followed by thermal annealing-induced co-assembly, new broad mirror-imaged CD bands emerged in the wavelength range of 200 nm to 500 nm (FIG. 9B). These CD responses can be attributed to the supramolecular chirality of the resulting chiral supramolecular fiber-like structures, which evolved through the transfer of chirality from the chiral additives to the star-like BCPs, and subsequently to the assembled supramolecular structures. The magnitude of the supramolecular chirality was quantitatively evaluated using the dissymmetry factor (g-factor), which reached a value of up to 0.038 (FIG. 10). This value surpasses those observed in chiral supramolecular structures constructed via co-assembly of achiral linear BCPs and chiral additives, as well as self-assembly of chiral BCPs.

An interesting observation is that when MA molecules were dissolved in DMF without being complexed with star-like BCPs, they underwent thermal decomposition during thermal annealing under the same conditions. This decomposition phenomenon was indicated by the disappearance of CD responses and can be attributed to the formation of the melt phase at high temperatures. This finding supports the observed lower supramolecular chirality with a g-factor of 0.003 when employing a molar ratio of AA repeating unit to MA equal to 1:1. In this particular system, the quantity of MA was insufficient to generate significant supramolecular chirality, as a portion of MA molecules, that did not form hydrogen bonding with AA, underwent thermal decomposition. Therefore, an excess amount of MA compared to the number of AA repeating units is necessary to ensure that all AA units form hydrogen bonding with MA molecules, thereby enabling efficient chirality transfer.

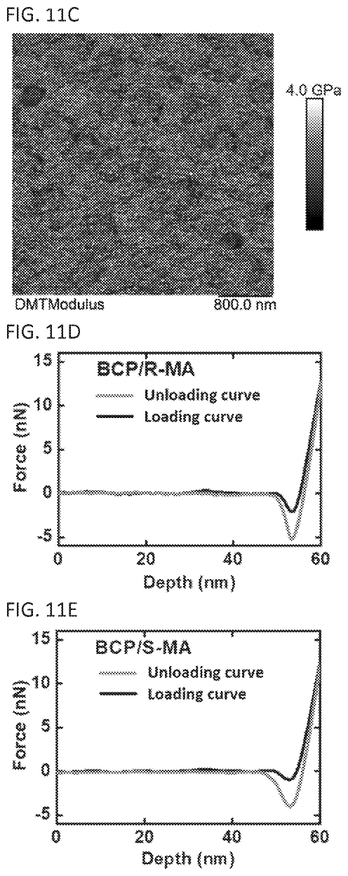

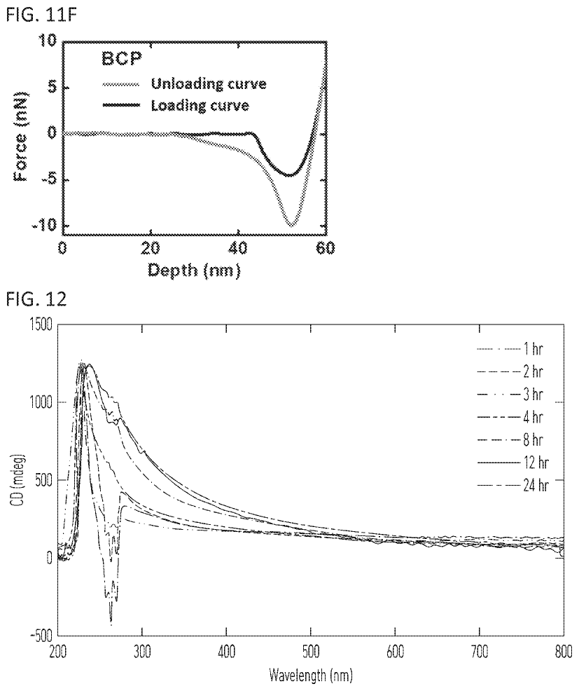

The impact of helical packing driven by co-assembly on the mechanical properties of the drop-cast polymer films was investigated using AFM nanoindentation. This well-established technique utilizes the Derjaguin-Muller-Toporov (DMT) model to quantitatively determine the elastic characteristics of materials at the nanoscale. The DMT modulus images of chiral supramolecular fiber-like structures showed a distribution of DMT modulus that aligned with a specific direction, corresponding to the handedness of the fiber-like structures, as shown in FIGS. 11A and 11B.

In contrast, the DMT modulus image of the pure star-like BCP film displayed a random distribution of DMT modulus without any discernible direction (FIG. 11C). To estimate elastic modulus values, the deformational behavior after contact, obtained from force-distance curves (FIGS. 11D to 11F), was analyzed. The reduced elastic modulus (Er) was calculated using equation (1), where S represents the contact stiffness measured as the slope of the tangent of the unloading curve at the maximum load and A is the projected contact area evaluated at maximum load (Pmax). The sample elastic modulus (E) is related to Er, as given by equation (2), in which uₛ and uᵢ are the Poisson's ratios of the sample and the indenter, respectively, and Eₛ and Eᵢ are the elastic modulus of the sample and the indenter, respectively.

$${E}_{r} = \frac{S \sqrt{π}}{2 \sqrt{{A}_{c}}} \qquad Equation ( 1 )$$

$$\frac{1}{{E}_{r}} = \frac{1 - {v}_{i}^{2}}{{E}_{i}} + \frac{1 - {v}_{s}^{2}}{{E}_{s}} \qquad Equation ( 2 )$$

Significantly, the elastic modulus of the chiral supramolecular fiber-like structures exhibited a remarkable increase of 0.106 GPa compared to the estimated value of 0.082 GPa for the pure star-like BCP film. Furthermore, the hardness (H), which can be calculated using equation (3), also experienced a substantial enhancement, rising from 8.4×10⁻³ N·m⁻² in the pure BCP film to 1.5×10⁻² N·m⁻² in the chiral supramolecular fiber-like structures. These findings strongly indicate that the tight helical packing induced by the co-assembly with chiral additives contributes to the improvement of mechanical properties.

$$H = \frac{{P}_{max}}{{A}_{c}} \qquad Equation ( 3 )$$

### 2-4. Mechanism Study of Hierarchical Chirality Transfer into Supramolecular Structures

In order to gain insights into the formation of chiral supramolecular structures during the co-assembly process under prolonged thermal annealing, we conducted time-dependent monitoring of CD responses (FIG. 12). In the case of the composite comprising star-like PAA-b-PS and S-MA, a distinctive bisignate exciton-type Cotton effect centered at 250 nm emerged after 1 hour of thermal annealing at 60° C. This CD behavior signifies the occurrence of active chromophore-chromophore interactions as the components approach each other, facilitated by the gradual evaporation of solvent molecules during thermal annealing. As the annealing time increased to 4 hours, the bisignate exciton-type Cotton effect weakened, and the two CD peaks with opposite signs merged, resulting in a single CD peak with a positive sign. Upon further annealing until 24 hours, the CD band broadened and intensified across a wide range of wavelengths, indicating the complete emergence of supramolecular chirality. This finding highlights the requirement of extended thermal annealing times, up to 24 hours, to induce optimized supramolecular chirality in co-assembled structures.

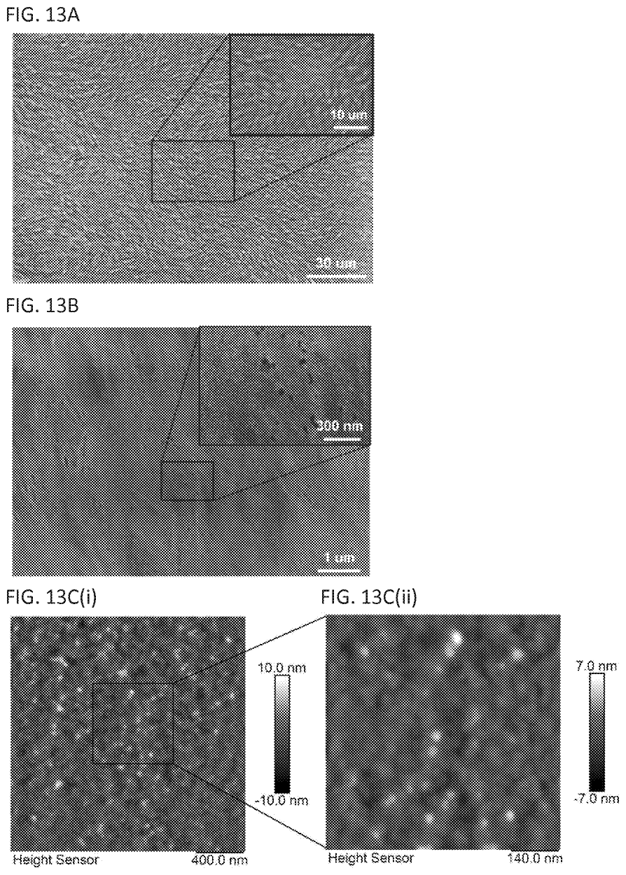

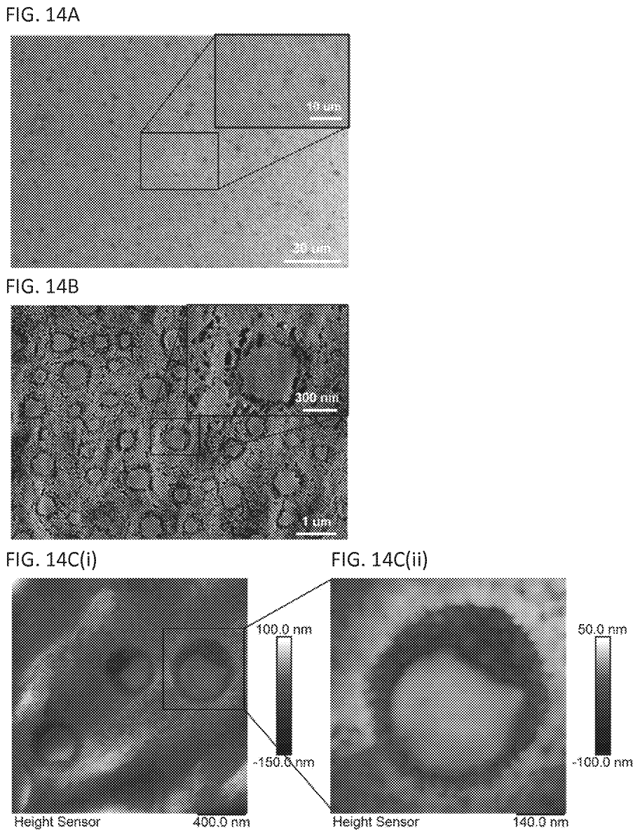

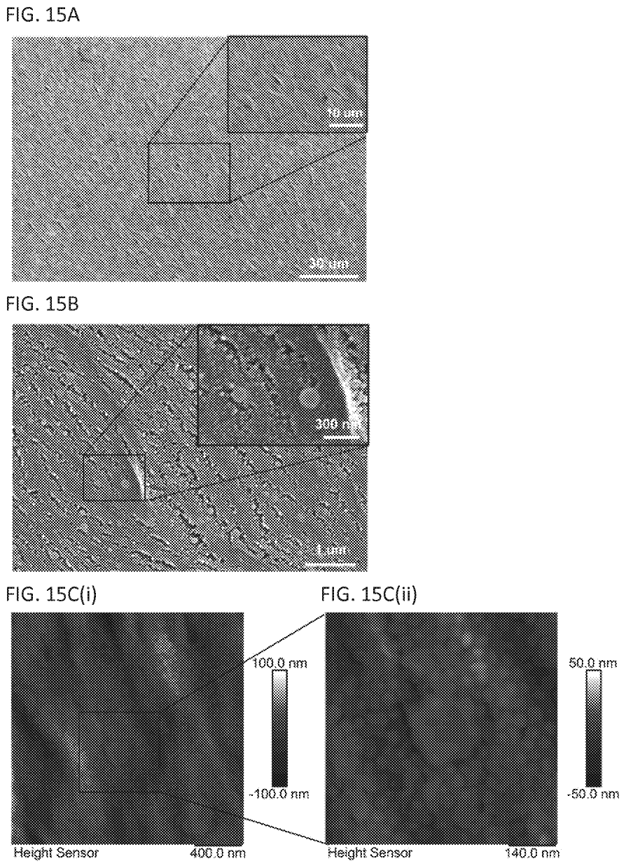

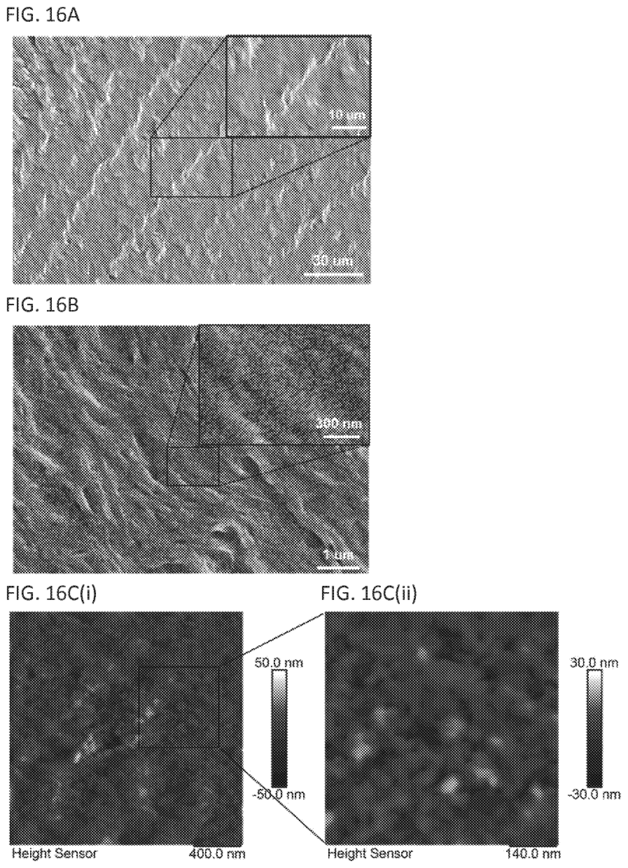

Moreover, we investigated the time-dependent morphological transformation of chiral supramolecular fiber-like structures during thermal annealing. To examine the chiral hierarchical supramolecular co-assembly mechanism, we utilized SEM and AFM techniques and collected images at different annealing times. Initially, after a thermal annealing period of 1 hour at 60° C., the concentration of the composite consisting of star-like PAA-b-PS and S-MA increased due to gradual solvent evaporation. This led to the adhesion of swollen spherical micelles to one another, reducing interfacial energy and resulting in the formation of irregular aggregates with a dot-like morphology (FIGS. 13A, 13B, 13C(i), and 13C(ii)). These smaller aggregates were evenly distributed on the substrate. Intriguingly, when the annealing time was extended to 2 hours, larger spherical aggregates comprising numerous dot-like small aggregates with diameters in the range of several hundred nanometers were observed (FIGS. 14A, 14B, 14C(i) and 14C(ii)). The presence of dark edge regions in these larger spherical aggregates can primarily be attributed to height differences caused by accelerated solvent evaporation from the top layer. As the annealing time continued up to 3 hours (FIGS. 15A, 15B, 15C(i) and 15C(ii)), the larger spherical aggregates underwent shrinkage, resulting in a decrease in size as solvent evaporation progressed. Eventually, after 4 hours of annealing, the larger spherical aggregates completely disappeared (FIGS. 16A, 16B, 16C(i) and 16C(ii)). This observation suggests that the larger spherical aggregates are kinetically driven, nonequilibrium metastable structures formed temporarily during the annealing process.

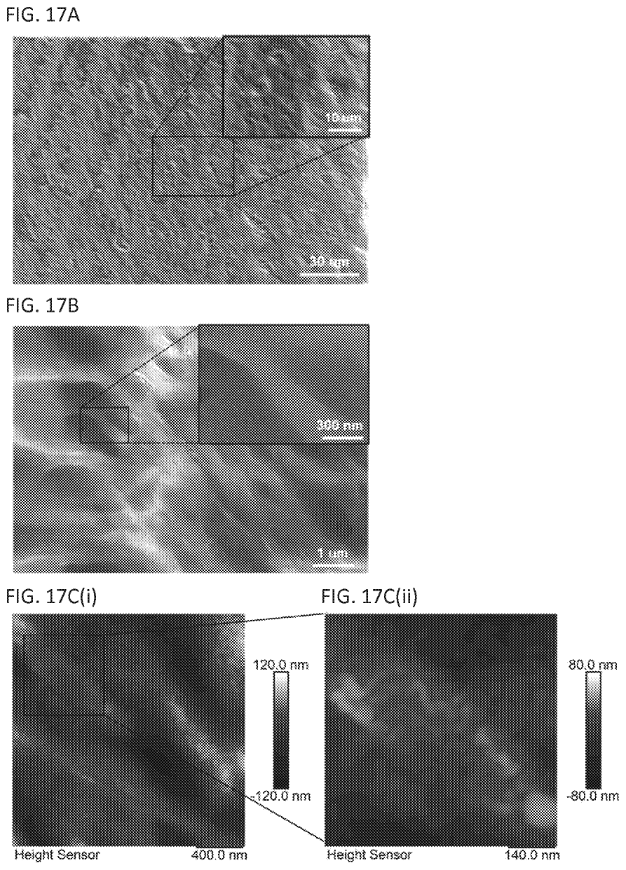

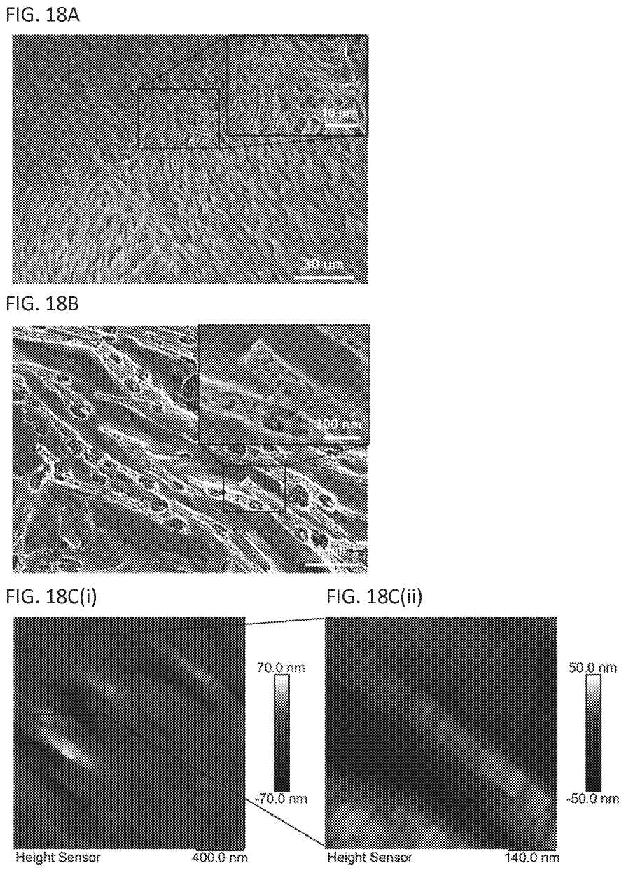

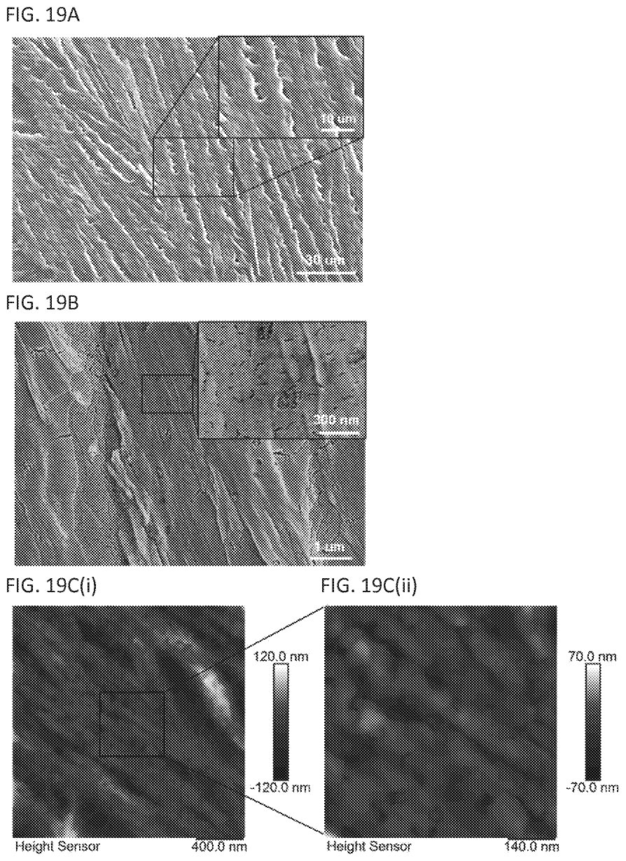

After 4 hours of annealing, directional co-assembly starts to appear. As the annealing time was extended up to 8 hours (FIGS. 17A, 17B, 17C(i) and 17C(ii)), elongated belt-like structures composed of closely packed dot-like small aggregates with a width of approximately 300 nm started to form. These belt-like structures exhibit a preferred structural growth direction as they pack together. This observation suggests that the structural evolution towards thermodynamically stable structures begins after at least 8 hours of annealing. Upon further prolonging the annealing time to 12 hours (FIGS. 18A, 18B, 18C(i) and 18C(ii)), the belt-like structures experience additional shrinkage, leading to a further reduction in width. This shrinkage can be attributed to the continuous evaporation of solvent molecules within both the dot-like aggregates and belt-like structures as the annealing process proceeds for a longer duration. Additionally, the belt-like structures became entangled with each other, resulting in a tightly packed structure that serves as a nucleation site for the growth of fiber-like structures. Finally, after 24 hours of annealing, the belt-like structures exhibited tight packing with a specific handedness, resulting in the formation of chiral fiber-like structures (FIGS. 19A, 19B, 19C(i) and 19C(ii)). These structures underwent complete shrinkage as the solvent molecules were completely evaporated during prolonged thermal annealing.

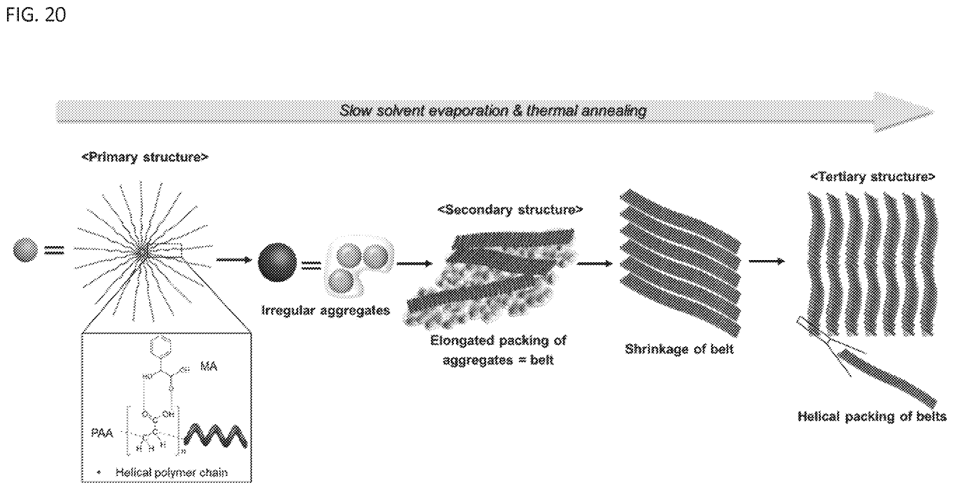

Based on the overall results, we propose a possible hierarchical supramolecular co-assembly mechanism (FIG. 20). Initially, the chiral star-like BCP is formed as a primary structure through the hybridization with MA, where the molecular chirality of MA is transferred to the conformational chirality of the PAA chains via hydrogen bonding. During the initial stages of thermal annealing, as solvent molecules begin to evaporate from the drop-cast solution, the primary structures come into close proximity, forming small irregular aggregates on the surface. It is worth noting that the presence of DMF, with its high boiling point (153° C.), plays a crucial role in the co-assembly process because it allows the polymers to maintain high mobility throughout the prolonged thermal annealing process so that the polymer chains with a helical phase can efficiently evolve into a thermodynamically stable structure with a specific handedness during the slow solvent evaporation process. As the DMF gradually evaporates, a concentration gradient is induced in the composite film. Therefore, these irregular dot-like aggregates in the top layer first undergo elongated packing, resulting in the formation of belt-like structures as a secondary structure on top of the composite film. These belt-like structures shrink and pack more tightly as the solvent further evaporates, while fresh belts emerge in the deeper layers. Finally, as a tertiary structure, the belt-like structures adopt helical packing, giving rise to the formation of fiber-like structures with a specific handedness as the solvent completely leaves the system. This helical packing can be attributed to the transfer of chirality from the helical phase of the PAA/MA block to thermodynamically stable supramolecular structures. The stepwise evolution of structures observed in this hierarchical supramolecular co-assembly mechanism results from the interplay between the molecular chirality of the MA component, the conformational chirality of the PAA/MA chains, and the gradual solvent evaporation-induced co-assembly.

### 2-5. Optimization of Multiple Parameters Influencing the Evolution of Chiral Supramolecular Structures

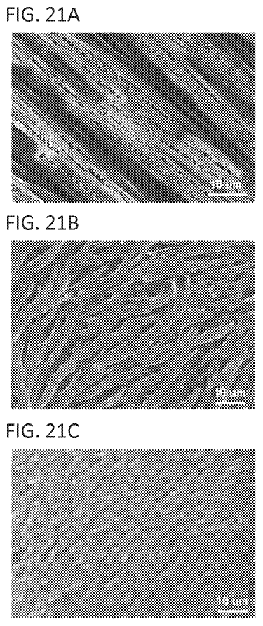

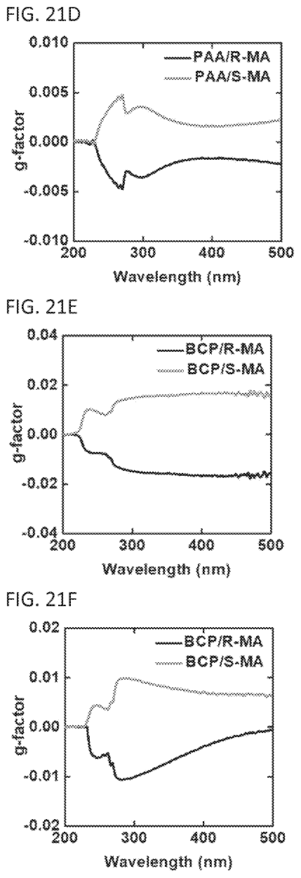

Several parameters have been found to affect the evolution of chiral supramolecular fiber-like structures obtained through the co-assembly of achiral polymers and R/S-MA. The utilization of star-like PAA homopolymers (i.e., sample 4 in Table 1), in contrast to star-like BCPs, resulted in the formation of irregular structures (FIG. 21A) due to the absence of phase separation caused by chemical incompatibility between the PAA and PS blocks. Thus, low supramolecular chirality with a g-factor of 0.005 was observed (FIG. 21D). To further comprehend the impact of the volume fraction of polymer block on chiral supramolecular co-assembly, we synthesized star-like PAA-b-PS diblock copolymers with an identical molecular weight for the PAA block (100 kg mol⁻¹) but varying molecular weights for the PS block, as outlined in Table 1. Notably, the g-factor spectra of composite films obtained from 24-hour thermal annealing exhibit a decrease in the g-factor with an increasing volume ratio of the PS block (FIGS. 21E and 21F). Furthermore, it was observed that the morphologies obtained after 24-hour annealing of sample 2 or 3, with higher and the highest volume ratios of the PS block (FIGS. 21B and 21C), exhibited similarities to the morphologies observed in sample 1 with shorter duration of thermal annealing (FIGS. 16A to 16C (ii), FIGS. 17A to 17C (ii), FIGS. 18A to 18C (ii)). These findings suggest that the increased volume ratio of the PS block results in the formation of assemblies that are kinetically trapped and fail to reach a thermodynamically stable state even after prolonged thermal annealing.

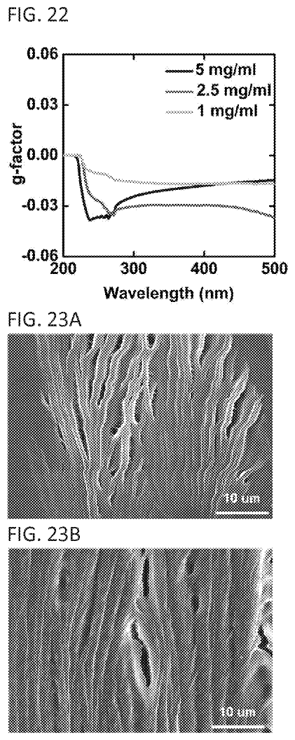

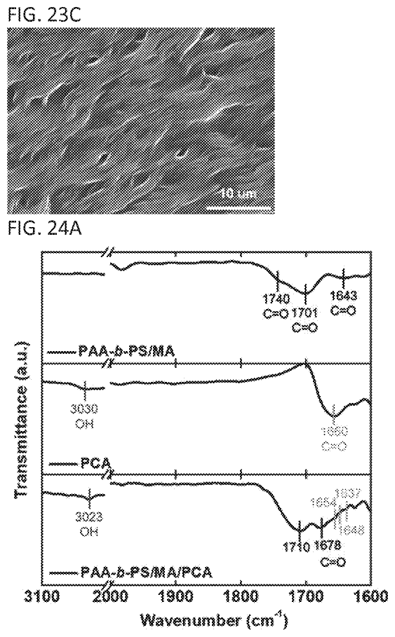

In addition to the volume ratio, we also controlled the concentration of the polymer composite consisting of star-like PAA-b-PS (i.e., sample 1 in Table 1) and R-MA used for drop-casting and thermal annealing. The g-factor spectra revealed that the highest level of supramolecular chirality was achieved at a concentration of 2.5 mg mL⁻¹ (FIG. 22). The observed decrease in g-factor values at concentrations higher or lower than 2.5 mg mL⁻¹ can be attributed to the morphological characteristics of the composite films. In FIG. 23A, it was found that at a concentration of 1.0 mg mL” 1, the composite films exhibited fiber-like structures without a distinct handedness, leading to weak supramolecular chirality. On the other hand, as the concentration increased up to 5.0 mg mL⁻¹, the morphologies obtained after a 24-hour annealing period displayed similarities to those observed at the optimal concentration of 2.5 mg mL⁻¹ after 8 hours of thermal annealing (FIG. 23C and FIGS. 17A to 17C(ii)). This result indicates that high concentration disturbs the evolution of thermodynamic chiral supramolecular structures. Consequently, it was proved that not only thermal annealing time but also volume ratio of polymer blocks and solution concentration can affect the thermodynamics and kinetics of chiral supramolecular co-assembly.

TABLE 1

| | M_{n, PAA} | M_{n, PS} | Volume ratio | |
|---|---|---|---|---|
| Sample | (kg mol⁻¹) | (kg mol⁻¹) | of PS block | g-factor |
| 1 | 100 | 190 | 0.655 | +0.038 (S), −0.031 (R) |
| 2 | 100 | 250 | 0.714 | +0.017 (R/S) |
| 3 | 100 | 320 | 0.762 | +0.01 (R/S) |
| 4 | 100 | | | 0.005 (R/S) |

### 2-6. Full-Color CPL Emission of Achiral Dye Molecules Incorporated into Chiral Supramolecular Assembly

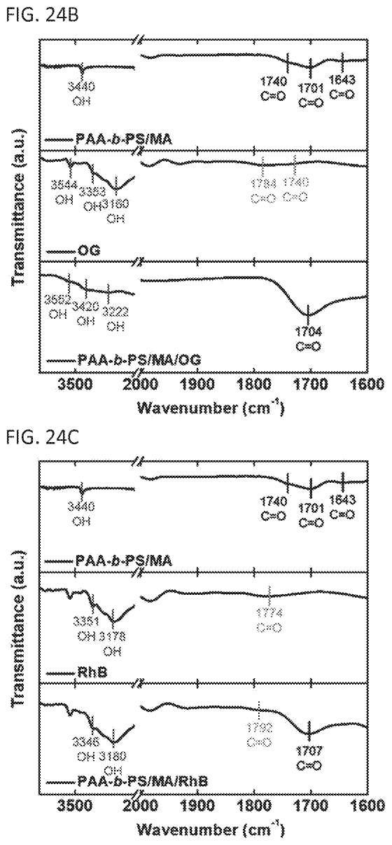

To fabricate CPL-active hybrid films, we introduced a range of achiral fluorescent dye molecules, specifically 1-pyrenecarboxylic acid (PCA), Oregon Green 488 (OG), and Rhodamine (RhB), into the chiral supramolecular co-assembly comprising star-like PAA-b-PS and R/S-MA, followed by a subsequent thermal annealing process. Here, PCA, OG, and RhB served as blue, green, and red fluorescent dye molecules, respectively. All of these dye molecules have a common characteristic: they possess a carboxylic acid group. This feature is essential for their effective participation in the co-assembly process, primarily through hydrogen bonding interactions with the PAA block. Analysis of the FTIR spectra of PAA-b-PS/MA, the dye molecules, and the hybrid films formed by incorporating the dyes into PAA-b-PS/MA provides evidence of hydrogen bonding interactions through [O—H . . . . O] linkages (FIGS. 24A to 24C). The FTIR spectra show clear shifts, broadening, and splitting of characteristic vibration bands related to carbonyl and hydroxyl groups, indicating the occurrence of hydrogen bonding interactions between the carboxylic acid groups of the dyes, MA, and PAA block.

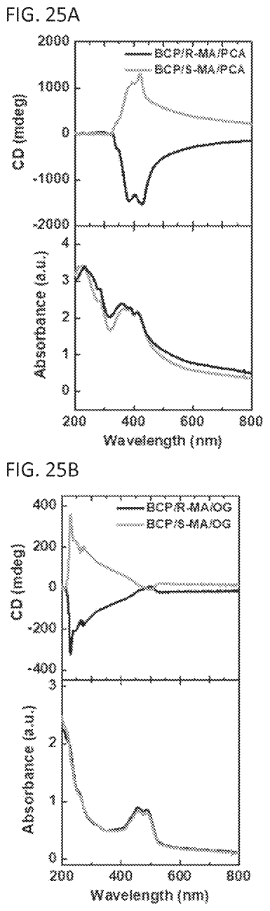

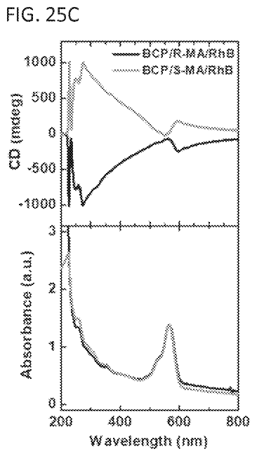

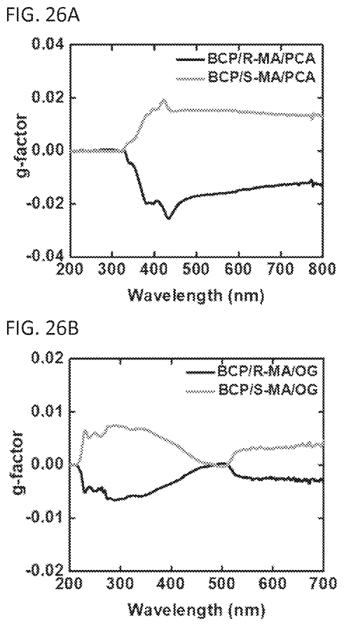

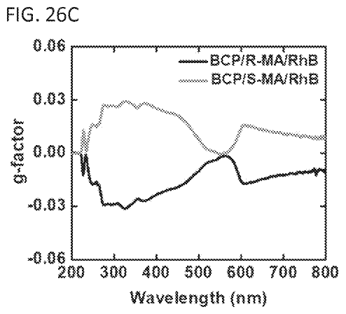

In the hybrid films incorporated with PCA molecules, the absorption spectra showed two prominent peaks, one situated at approximately 360 nm and the other at around 410 nm (FIG. 25A). The peak at a shorter wavelength corresponds to the π-π* transition of the pyrene chromophore, while the longer peak can be attributed to the aggregated state of PCA molecules that is induced via intermolecular interactions such as hydrogen bonding and It-I stacking. Notably, the CD spectra revealed pronounced CD peaks within a broad wavelength range, spanning from 330 nm to 800 nm. These peaks coincide with the two absorption peaks identified. Furthermore, the CD spectra exhibited mirror symmetric CD responses, which were dependent on the molecular chirality of the additives used in the co-assembly process. An intriguing observation was that the maximum g-factor at 430 nm is as high as 2.6×10⁻² (FIG. 26A). When OG molecules were incorporated into the hybrid films, absorption bands attributable to the π-π* transition of the OG chromophores were detected at around 470 nm (FIG. 25B). In the case of the RhB-incorporated hybrid films, absorption peaks arising from the π-π* transition were observed at 565 nm (FIG. 25C). It is pertinent to note that band splitting appeared in both OG- and RhB-incorporated samples. This phenomenon was attributed to the aggregation mediated by intermolecular interactions, which have the potential to alter the energy levels available for electronic transitions. The CD spectra for both OG- and RhB-incorporated hybrid films exhibited mirror-imaged characteristic CD signals that were aligned with their respective absorption bands. The maximum g-factors were 7.0×10⁻³ and 3.0×10⁻² for the OG- and RhB-incorporated hybrid films, respectively (FIGS. 26B and 26C). It is important to note that, in the absence of a thermal annealing process, the transfer of chirality to the dye molecules does not occur, as evidenced by the lack of a CD response. This result indicates that chirality cannot be imparted to achiral dye molecules solely through hydrogen bonding interactions. Instead, the chiral arrangement of the dye molecules via the co-assembly process, induced by thermal annealing, is necessary for the transfer of chirality to achiral dye molecules. Consequently, these collective observations substantiate the successful transfer of chirality to the achiral dye molecules via the co-assembly process.

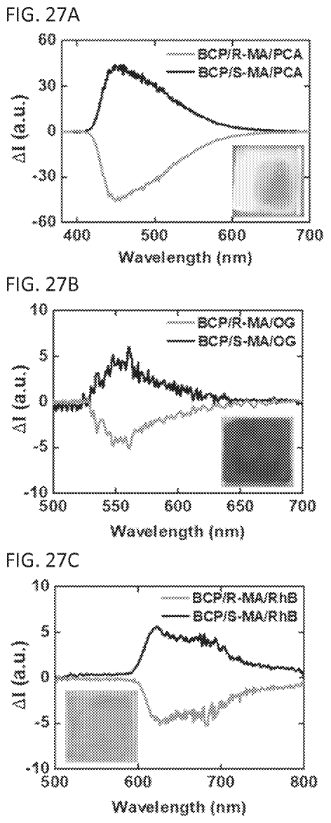

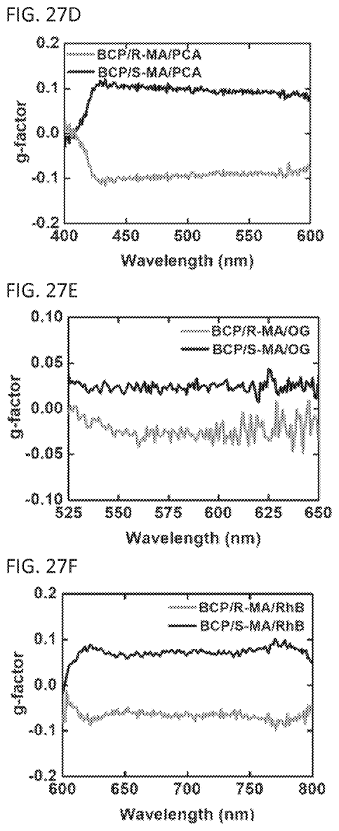

Next, we investigated the CPL emission of hybrid films incorporating various dyes. The hybrid films incorporating PCA molecules exhibited blue CPL emission centered around 450 nm (FIG. 27A). Meanwhile, the hybrid films incorporating OG and RhB molecules displayed green and red CPL emission at approximately 550 nm and 625 nm, respectively (FIGS. 27B and 27C). The handedness of the CPL emission was the geometric handedness of the chiral supramolecular structures. The luminescence dissymmetry factor (glum), calculated using equation (4), serves as an important parameter to quantify the magnitude of CPL. In this equation, IL represents the intensity of left-handed CPL, while IR denotes the intensity of right-handed CPL. Remarkably, CPL-active hybrid films with PCA, OG, and RhB molecules exhibited outstanding glum values of 0.11, 0.03, and 0.09, respectively (FIGS. 27D to 27F). Additionally, the hybrid films demonstrated higher QY values of 29.2%, 16%, and 12.4% for PCA, OG, and RhB, respectively, compared to pure dye films. In pure dye films, the emission was completely quenched after annealing due to the aggregation-caused quenching (ACQ) effect. However, in the hybrid films formed via co-assembly, the interactions between the PAA block and dye molecules hindered intermolecular interaction and electron exchange, ultimately mitigating the ACQ effect. The CPL performance achieved through the star-like BCP-based supramolecular co-assembly is compared with those of chiral supramolecular materials consisting of achiral dye molecules and other polymers (Table 2). This comparison serves to highlight the effectiveness of our strategy in enabling efficient chirality transfer to achiral dye molecules, consequently leading to high CPL activities. As a result, these results validate that the resulting supramolecular chiral co-assemblies of star-like BCP, R/S-MA, and achiral dye molecules not only exhibit remarkable CPL-active behaviors but also possess high luminescence efficiencies in the solid state. Furthermore, the study demonstrates that this strategy can be generalized, allowing for the incorporation of a wide range of achiral dye molecules for CPL emission, if they possess functional groups capable of participating in the co-assembly process via hydrogen bonding.

$$Luminescence dissymmetry factor ( {g}_{lum} ) = \frac{2 ( {I}_{L} - {I}_{R} )}{( {I}_{L} + {I}_{R} )} \qquad Equation ( 4 )$$

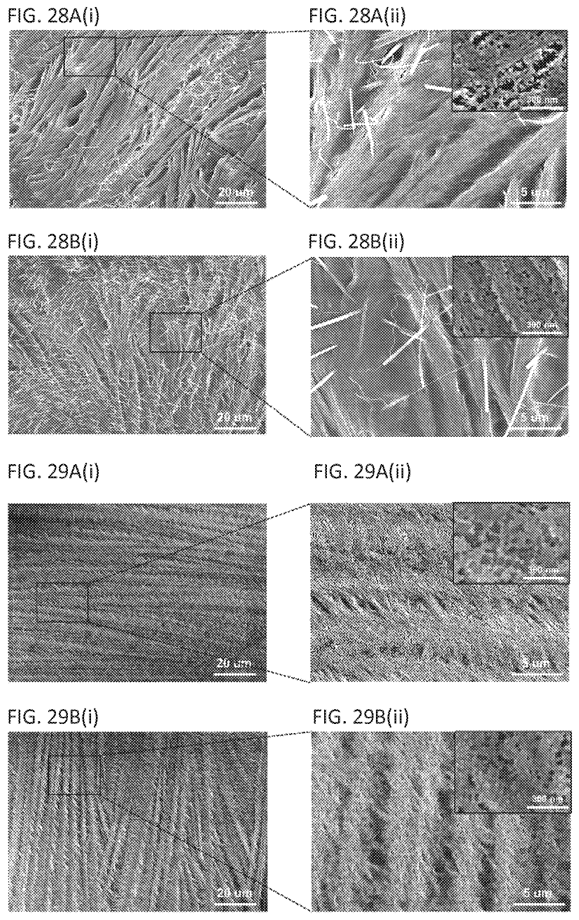

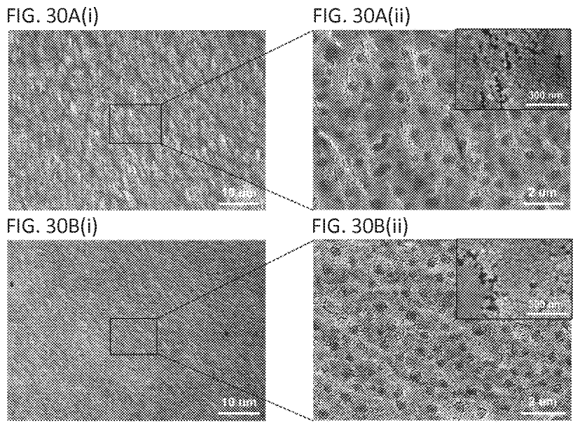

The morphologies of the obtained CPL-active hybrid films, which incorporate PCA, OG, and RhB molecules, were characterized by employing SEM. The SEM images of hybrid films incorporating PCA and OG molecules unveil the formation of supramolecular fiber-like architectures exhibiting a distinct handedness (FIGS. 28A(i), 28A(ii), 28B(i) and 28B(ii), FIGS. 29A(i), 29A(ii), 29B(i) and 29B(ii)), which are consistent with the supramolecular structures obtained via the co-assembly of star-like BCP and R/S-MA in absence of dye molecules. In FIGS. 28A(i) and 28A(ii), the existence of PCA crystalline aggregates is also observed. However, when RhB molecules participate in the co-assembly process (FIGS. 30A(i), 30A(ii), 30B(i) and 30B(ii)), the obtained structures are similar to the supramolecular morphology of star-like BCP/S-MA obtained after 3 hours of thermal annealing (FIGS. 15A to 15C (ii)). This finding suggests that the presence of bulky dye molecules hampers the achievement of a thermodynamically stable state. This hindrance is attributed to the interactions between the PAA block and RhB molecules, which impede the mobility of polymer chains and the evolution of chiral supramolecular structures.

TABLE 2

| Chirality | | | | |
|---|---|---|---|---|
| inducer | System | gₗᵤₘ | QY (%) | |
| Chiral | Achiral poly(1,4- | 2.3 × | — | Compar- |
| additive | butadiene)-b-poly(ethylene | 10⁻² | | ative |
| | oxide) (PBd-b-PEO) + L/D- | | | Example |
| | tartaric acid + PCA | | | |
| Chiral | Chiral polymer nanofiber + | 2.5 × | — | Compar- |
| polymer | 5-(dimethylamino)-N- | 10⁻² | | ative |
| nanofiber | (prop-2-yn-1- | | | Example |
| (induced | yl)naphthalene-1- | | | |
| by α- | sulfonamide | | | |
| pinene) | | | | |
| Chiral | Chiral polyisocyanide- | ~3.0 × | — | Compar- |
| isocyanide | based supramolecular | 10⁻² | | ative |
| | polymer + achiral | | | Example |
| | fluorescent dyes | | | |
| Chiral | 1) PBd-b-PEO + D-/L- | 1) 1.0 × | 1) 28% | Compar- |
| additive | dibenzoyl TA + PCA | 10⁻² | 2) — | ative |
| | 2) PBd-b-PEO + R/S-MA + | 2) 3.0 × | | Example |
| | 9-anthracenecarboxylic acid | 10⁻² | | |
| Chiral | Polystyrene- | 0.8 × | — | Compar- |
| block | b-poly(L-lactide) + six- | 10⁻² | | ative |
| copolymer | carboxylategroup | | | Example |
| | modified hexathiobenzene | | | |
| | compound | | | |
| Chiral | Chiral binaphthyl | 5.6 × | 38.8% | Compar- |
| polymer | polymer + pyrene- | 10⁻² | | ative |
| | naphthalimide dye | | | Example |
| Chiral | Polyaniline helical | ~2.5 × | — | Compar- |
| additive | microfiber + R/S- | 10⁻² | | ative |
| | camphorsulfonic | | | Example |
| | acid + tetraphenylethylene | | | |
| Chiral | Chiral polyacetylene-based | 4.2 × | 38.8% | Compar- |
| polymer | polymer + 9,10- | 10⁻² | | ative |
| | bis(phenylethynyl)anthra- | | | Example |
| | cene | | | |
| Chiral | Racemic polyacetylene + | 9.0 × | — | Compar- |
| additive | chiral α-pinene + green | 10⁻² | | ative |
| | fluorescein (X18) | | | Example |
| Chiral | Stat-like PAA-b-PS + | 1) 0.11 | 1) 29.2% | Example |
| additive | R/S-MA + PCA/OG/RhB | 2) 0.03 | 2) 16.0% | |
| | | 3) 0.09 | 3) 12.4% | |

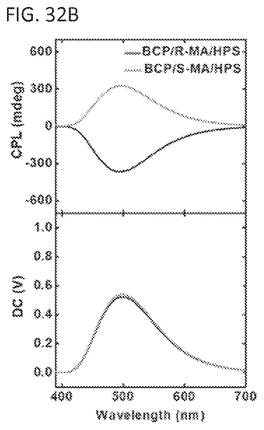

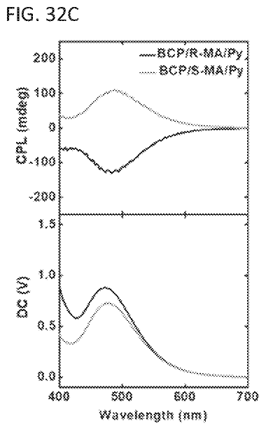

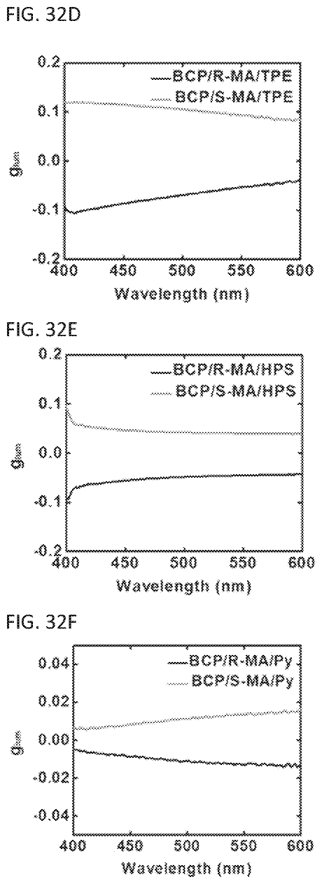

Additionally, circularly polarized luminescence (CPL) materials incorporating hydrophobic organic dyes were prepared and characterized. We introduced hydrophobic dyes, such as 1,1,2,2-tetraphenylethylene (TPE), 1,1,2,3,4,5-hexaphenyl-1H-silole (HPS), or pyrene (Py), into the chiral supramolecular co-assembly including star-like PAA-b-PS and R/S-MA. Specifically, the star-like PAA-b-PS, R/S-MA, and each of the dyes were dissolved in a DMF solution. The molar ratios of the AA repeating units to TPE, HPS, and Py were maintained at 5:1, 10:1, and 10:1, respectively. Subsequently, the solution was drop-casted, followed by thermal annealing at 60° C. and subsequent characterization. FIGS. 32A to 32F show (FIG. 32A, FIG. 32B, FIG. 32C) CPL spectra and corresponding DC spectra, and (FIG. 32D, FIG. 32E, FIG. 32F) glum spectra of chiral supramolecular hybrid films incorporating TPE, HPS, and Py as hydrophobic organic dyes. The chiral co-assemblies incorporating TPE, HPS, and Py exhibited distinct CD and CPL signals along with excellent glum values. Furthermore, the photoluminescence quantum yield (PLQY) was significantly enhanced compared to pure dye films prepared under the same conditions. In pure dye films of the same concentration, the intermolecular distance is large due to low concentration and incomplete aggregation; moreover, intramolecular motions are promoted during thermal annealing, accelerating non-radiative relaxation and emission degradation. In contrast, within the chiral co-assembly, the intramolecular motion of the dye molecules is effectively suppressed by the interactions with PAA-b-PS/(R/S)-MA and the It-It interactions between the hydrophobic PS blocks and the hydrophobic dyes. Consequently, the dyes are immobilized within the chiral supramolecular structure, leading to enhanced emission stability.

### 2.7 Preparation of Perovskite Nanocrystal-Based Circularly Polarized Luminescence (CPL) Materials

1) First, star-like PAA-b-PS (5 mg) and R/S-MA were added to 1 mL of a mixed solvent of dimethylformamide (DMF) and toluene (volume ratio=1:1) and stirred vigorously at room temperature for 2 days (molar ratio of AA monomer to mandelic acid=1:2).
2) Simultaneously, star-like PAA-b-PS (5 mg) was added to 1 ml of DMF and stirred vigorously at room temperature for 1 day. Subsequently, perovskite precursors, CsBr and PbBr₂ (molar ratio of perovskite precursors to AA monomer=2:1), were added, followed by vigorous stirring for at least 5 days at room temperature to obtain a mixed solution. Then, 100 μL of the mixed solution was dropped into 5 ml of toluene to form perovskite nanocrystals within the PAA cores. After precipitation by adding n-hexane, the precipitate was re-dissolved in toluene.
3) The solution containing star-like PAA-b-PS and R/S-MA obtained in step 1) and the CsPbBr₃ nanocrystal solution formed within the star-like PAA-b-PS obtained in step 2) were mixed by stirring, uniformly applied to a substrate, and thermally treated at 60° C. for 1 hour.

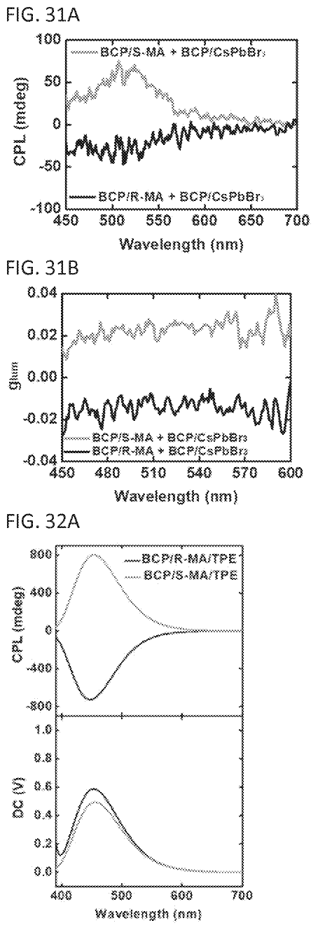

Referring to FIGS. 31A and 31B, the hybrid film incorporating CsPbBr₃ nanocrystals exhibited green CPL emission centered at about 510 nm. The handedness of the CPL is controlled by the handedness of the supramolecular chiral structure, which is determined by the molecular chirality of the mandelic acid. A high luminescence dissymmetry factor of up to 0.027 was observed, confirming that the chiral supramolecular structure technology of the present disclosure may impart chirality transfer and CPL activity not only to fluorescent dye molecules but also to perovskite nanocrystals.

### 3. Conclusion

In conclusion, this chapter unveils an efficient, yet straightforward strategy to fabricate chiral, fiber-like supramolecular structures. This approach incorporates the co-assembly of the achiral star-like PAA-b-PS with 21 polymer arms and R/S-MA. Both the AA repeating unit and MA possess several hydrogen bonding moieties, facilitating strong noncovalent interactions between the BCP and MA within the resilient environment offered by covalently bonded unimolecular micelles. This leads to the emergence of pronounced supramolecular chirality, exhibiting a g-factor as high as 0.038. We also provided an in-depth exploration of the mechanisms that drive the formation of these chiral supramolecular structures, as illustrated by time-dependent CD results and morphological changes. Our investigations revealed a hierarchical progression of structures, transitioning from chiral star-like BCPs to belt-like nanostructures, ultimately evolving into fiber-like microstructures with a specific handedness. Furthermore, by integrating diverse achiral fluorescent dye molecules into the chiral supramolecular co-assembly, we successfully fabricated full-color CPL-active films, achieving a glum of up to 0.11. By mitigating aggregation-induced fluorescence quenching and thermal degradation of dye molecules via effective encapsulation within the star-like BCP through hydrogen bonding, we achieved enhanced QY values relative to those of pure dye films. Ultimately, this research introduces a novel supramolecular co-assembly strategy, capitalizing on star-like BCP as a building block for constructing intricate chiral supramolecular structures and high-performing CPL-active hybrid films. This exemplifies the broad applicability and superiority of our developed strategy and underscores its promising prospects for future applications in related scientific domains.

The above description of the present disclosure is provided for the purpose of illustration, and it would be understood by those skilled in the art that various changes and modifications may be made without changing technical conception and essential features of the present disclosure. Thus, it is clear that the above-described examples are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

1. A chiral supramolecular high-order structure, comprising:
an achiral star-like block copolymer including a poly(acrylic acid) as a core block polymer and a shell block polymer; and
a chiral additive;
wherein the poly(acrylic acid) and the chiral additive have a noncovalent interaction, and
wherein a handedness of the chiral supramolecular high-order structure is determined by the chirality of the chiral additive.

2. A chiral supramolecular high-order structure of claim 1,
wherein the shell block polymer is a hydrophobic polymer.

3. A chiral supramolecular high-order structure of claim 2,
wherein the hydrophobic polymer includes at least one selected from the group consisting of polystyrene, polyethylene, polypropylene, polybutadiene, polyaniline, polythiophene, poly(phenylene vinylene), and derivatives thereof.

4. A chiral supramolecular high-order structure of claim 1,
wherein the chiral additive includes at least one selected from the group consisting of mandelic acid, tartaric acid, aspartic acid, tyrosine, ibuprofen, and hydroxymandelic acid.

5. A chiral supramolecular high-order structure of claim 1,
wherein the achiral star-like block copolymer has a star-like structure including a plurality of arms extending from the core block polymer.

6. A chiral supramolecular high-order structure of claim 1,
wherein a volume ratio of the core block polymer to the shell block polymer is 1:1 to 1:4.

7. A chiral supramolecular high-order structure of claim 1,
wherein the chiral supramolecular high-order structure forms a helical fiber-like structure.

8. A chiral supramolecular high-order structure of claim 1,
wherein a dissymmetry factor (g-factor) of the chiral supramolecular high-order structure is 0.03 or more.

9. A circularly polarized luminescence structure, comprising:
the chiral supramolecular high-order structure according to claim 1; and
an achiral fluorophore;
wherein a circular polarization direction of the circularly polarized luminescence structure is determined by the handedness of the chiral supramolecular high-order structure.

10. The circularly polarized luminescence structure of claim 9,
wherein the achiral fluorophore is a dye compound including at least one selected from the group consisting of 1-pyrenecarboxylic acid, Oregon Green 488, rhodamine, anthracene-9-carboxylic acid, terephthalic acid, naphthalene dicarboxylic acid, coumarin, coumarin-6-carboxylic acid, 7-hydroxy-4-methylcoumarin-3-carboxylic acid, naphthalene-1,8-dicarboxylic acid, tetraphenylethylene, hexaphenylsilole, pyrene, perylene, anthracene, and Nile red; a semiconductor compound including at least one selected from CdS, CdSe, and PbS; a perovskite nanocrystal compound including at least one selected from CsPbX₃ (cesium lead halide) and MAPbX₃ (methylammonium lead halide); or an upconversion nanoparticle including at least one selected from NaYF₄:Yb, Er (ytterbium and erbium doped NaYF₄) and NaYF₄:Yb, Tm (ytterbium and thulium doped NaYF₄).

11. The circularly polarized luminescence structure of claim 9,
wherein a luminescence dissymmetry factor (glum) of the circularly polarized luminescence structure is 0.03 or more.

12. A method of preparing a chiral supramolecular high-order structure, comprising:
preparing a mixed solution including an achiral star-like block copolymer including a poly(acrylic acid) as a core block and a shell block, a chiral additive, and a solvent;
stirring the mixed solution; and
applying the stirred mixed solution and performing thermal annealing;
wherein the poly(acrylic acid) and the chiral additive have a noncovalent interaction, and
wherein a handedness of the chiral supramolecular high-order structure is determined by the chirality of the chiral additive.

13. The method of claim 12,
wherein the solvent includes at least one selected from the group consisting of dimethylformamide, toluene, tetrahydrofuran, ethyl acetate, 1,4-dioxane, dimethyl sulfoxide, acetonitrile, acetone, ethanol, and methanol.

14. The method of claim 12,
wherein a molar ratio of an acrylic acid repeating unit of the poly(acrylic acid) to the chiral additive is 1:1 to 1:3.

15. The method of claim 12,
wherein the thermal annealing is performed at a temperature range of 50° C. to 70° C.

16. The method of claim 12,
wherein the thermal annealing is performed for 1 hour to 48 hours.

17. The method of claim 12,
wherein a volume ratio of the core block polymer to the shell block polymer is 1:1 to 1:4.

18. The method of claim 12,
wherein a concentration of the mixed solution is more than 1 mg mL⁻¹ and up to 10 mg mL⁻¹.

19. The method claim 12, further comprising:
prior to performing the thermal annealing,
adding an achiral fluorophore to the stirred mixed solution and stirring it.
